(19) United States
(12) Patent Application Publication
(10) Pub. No.: US 2010/0103417 A1
(43) Pub. Date: Apr. 29, 2010

(54) Optical Characteristic Measuring Apparatus, Optical Characteristic Measuring Method, and Optical Characteristic Measuring Unit

(76) Inventors: Yukitoshi Otani, Tokyo (JP); Mizue Ebisawa, Saitama-ken (JP)

Correspondence Address: Reed Smith, 3110 Fairview Park Drive, Suite 1400, Falls Church, VA, 22042, US

(21) Appl. No.: 12/225,384

(22) PCT Filed: Mar. 16, 2007
(86) PCT No.: PCT/JP2007/055355

§ 371 Date: Nov. 4, 2008

(30) Foreign Application Priority Data
Mar. 20, 2006 (JP) 2006-077694

(51) Int. Cl. G01J 4/00

(52) U.S. Cl. 356/364

(57) ABSTRACT

An optical characteristic measuring device includes: an optical system (10), a light intensity information acquisition unit (40) for acquiring light intensity information on the light to be measured, and an operation process unit (60). The optical system (10) introduces the light emitted from a light source (12) to a sample (100) via a polarizer (22), a ½ wavelength plate (24), and a first ¼ wavelength plate (26), and introduces the light emitted from the sample (100) to a reception unit (14) via a second ¼ wavelength plate (34) and a detector (36). The ½ wavelength plate (24), the first and the second ¼ wavelength plate (26, 34) and the detector (36) are configured so as to be rotated. The light intensity information

### TECHNICAL FIELD

The present invention relates to an optical characteristic measuring apparatus, an optical characteristic measuring method, and an optical characteristic measuring unit that measure the optical characteristics of a measurement target.

### BACKGROUND ART

Technology that analyzes the optical characteristics of a substance utilizing matrix elements of a matrix that indicates the optical characteristics of the measurement target has been known. Specifically, the optical characteristics (physical quantity that indicates the optical characteristics) of the measurement target can be measured by identifying matrix elements of a matrix that indicates the optical characteristics of the measurement target.

A Mueller matrix has been known as a matrix that indicates the optical characteristics of the measurement target. Various technologies for calculating matrix elements of the Mueller matrix have been known.

Specifically, JP-A-2005-116732, JP-T-2000-502461, Collins, R. W. and Y. T. Kim, “Ellipsometry for thin-film and Surface analysis”, Ann. Chem., 62, pp. 887a to 900a (1990), Azzam, R. M. A., “Photopolarimetric Measurement of the Mueller Matrix by Fourier Analysis of Single Detected Signal”, Opt. Lett. 2, pp. 148 to 150 (1978), and D. Lara and C. Dainty, “Polarization sensitive imaging using a cofocal Mueller matrix ellipsometer”, ICO topical Meeting on Polarization Optics, pp. 226 to 227 (2003) disclose such technologies.

### DISCLOSURE OF THE INVENTION

The technologies disclosed in the above-mentioned documents have the following problems.

According to the technology disclosed in JP-A-2005-116732, it is difficult to measure the matrix elements of the Mueller matrix with high accuracy.

According to the technology disclosed in JP-T-2000-502461, a high voltage is required for the measurement. Moreover, it is necessary to utilize an expensive modulation element.

According to the technology disclosed in Collins, R. W. and Y. T. Kim, “Ellipsometry for thin-film and Surface analysis”, Ann. Chem., 62, pp. 887a to 900a (1990), since at least twelve spectral intensities are required to calculate nine matrix elements of the Mueller matrix, it is difficult to implement efficient measurements.

According to the technology disclosed in Azzam, R. M. A., “Photopolarimetric Measurement of the Mueller Matrix by Fourier Analysis of Single Detected Signal”, Opt. Lett. 2, pp. 148 to 150 (1978), measurements take time. Moreover, since at least 48 spectral intensities are required to calculate all of the sixteen matrix elements of the Mueller matrix, it is difficult to implement efficient measurements.

According to the technology disclosed in D. Lara and C. Dainty, “Polarization sensitive imaging using a cofocal Mueller matrix ellipsometer”, ICO topical Meeting on Polarization Optics, pp. 226 to 227 (2003), it is necessary to use a high voltage for measurements. Moreover, it is necessary to use an expensive optical element. In addition, since four detectors are required, it is difficult to implement a simple device configuration.

An objective of the invention is to provide an optical characteristic measuring apparatus and an optical characteristic measuring method that can calculate the matrix elements of a matrix (Mueller matrix) that indicates the optical characteristics of a measurement target by a relatively simple configuration using a small amount of measurement data, and an optical characteristic measuring unit that measures the optical characteristics of a measurement target.

(1) According to the invention, there is provided an optical characteristic measuring apparatus that measures the optical characteristics of a measurement target, the optical characteristic measuring apparatus comprising:

an optical system that includes a light source that emits light having a predetermined wavelength, at least five optical elements, and a light-receiving section that receives measurement light obtained by modulating the light by using the at least, five optical elements and the measurement target;

a light intensity information acquisition section that acquires light intensity information relating to the measurement light; and

a calculation section that performs a calculation process that calculates at least one of matrix elements of a matrix that indicates the optical characteristics of the measurement target based on a theoretical expression for the light intensity of the measurement light and the light intensity information relating to the measurement light,

the at least five optical elements including a first polarizer, a second polarizer, a half-wave plate, a first quarter-wave plate, and a second quarter-wave plate;

the optical system being configured so that the light emitted from the light source is incident on the measurement target through the first polarizer, the half-wave plate, and the first quarter-wave plate, and the light modulated by the measurement target is incident on the light-receiving section through the second quarter-wave plate and the second polarizer, at least the half-wave plate, the first quarter-wave plate, the second quarter-wave plate, and the second polarizer being rotatable;

the light intensity information acquisition section acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter-wave plate, and the second polarizer; and

the calculation section calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables.

According to the invention, the theoretical expression for the light intensity of the measurement light includes the matrix elements of the matrix that indicates the optical characteristics of the measurement target as variables. The theoretical expression for the light intensity of the measurement light reflects the principal axis directions of the optical elements. Therefore, one relational expression that indicates the relationship among the matrix elements of the matrix that indicates the optical characteristics of the measurement target can be derived by utilizing one piece of light intensity information acquired by the light intensity information acquisition section and the principal axis direction information relating to the optical elements.

Since the acquired light intensity and the coefficient included in the light intensity theoretical expression change when the principal axis directions of the optical elements are changed, the light intensity theoretical expression changes.

Therefore, the matrix elements of the matrix that indicates the optical characteristics of the measurement target can be calculated by appropriately setting the principal axis directions of the optical elements, deriving a plurality of relational expressions that indicate the relationship among the matrix elements of the matrix that indicates the optical characteristics of the measurement target, and solving the relational expressions as simultaneous equations.

In the invention, the light intensity information acquisition section acquires the first light intensity information to the Nth (N is an integer equal to or larger than two) light intensity information (i.e., N pieces of light intensity information). The first light intensity information to the Nth light intensity information indicate the light intensity information relating to the measurement light obtained by the optical system 10 set under the first to Nth conditions, respectively. The first to Nth conditions differ in at least one of the principal axis directions of the optical elements (first and second half-wave plates).

For example, the first light intensity information is acquired using the optical system set under the first condition. The second light intensity information is then acquired using the optical system set under the second condition. N relational expressions including the matrix elements of the matrix that indicates the optical characteristics of the measurement target as variables may be derived by repeating the above process N times.

The matrix elements can be calculated as values by solving the relational expressions with respect to each matrix element. Since each matrix element indicates the optical characteristics of the measurement target, the optical characteristics of the measurement target can be measured by calculating the matrix elements.

According to the invention, since the optical system can be formed using only the rotational optical elements, the optical system can be set and changed accurately and quickly. According to the invention, an optical characteristic measuring apparatus that can accurately and efficiently measure optical characteristics can be provided.

(2) According to the invention, there is provided an optical characteristic measuring apparatus that measures the optical characteristics of a measurement target, the optical characteristic measuring apparatus comprising:

a light intensity information acquisition section that acquires light intensity information relating to measurement light modulated by the measurement target and at least five optical elements included in an optical system; and

a calculation section that performs a calculation process that calculates at least one of matrix elements of a matrix that indicates the optical characteristics of the measurement target based on a theoretical expression for the light intensity of the measurement light and the light intensity information relating to the measurement light,

the at least five optical elements including a first polarizer, a second polarizer, a half-wave plate, a first quarter-wave plate, and a second quarter-wave plate, at least the half-wave plate, the first quarter-wave plate, the second quarter-wave plate, and the second polarizer being rotatable;

the measurement light being obtained by causing light having a predetermined wavelength emitted from a light source to be incident on the measurement target through the first polarizer, the half-wave plate, and the first quarter-wave plate, and causing the light modulated by the measurement target to be incident on a light-receiving section through the second quarter-wave plate and the second polarizer,

the light intensity information acquisition section acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter-wave plate, and the second polarizer, and

the calculation section calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables.

According to the invention, the theoretical expression for the light intensity of the measurement light includes the matrix elements of the matrix that indicates the optical characteristics of the measurement target as variables. The theoretical expression for the light intensity of the measurement light reflects the principal axis directions of the optical elements. Therefore, one relational expression that indicates the relationship among the matrix elements of the matrix that indicates the optical characteristics of the measurement target can be derived by utilizing one piece of light intensity information acquired by the light intensity information acquisition section and the principal axis direction information relating to the optical elements.

Since the acquired light intensity and the coefficient included in the light intensity theoretical expression change when the principal axis directions of the optical elements are changed, the light intensity theoretical expression changes.

Therefore, the matrix elements of the matrix that indicates the optical characteristics of the measurement target can be calculated by appropriately setting the principal axis directions of the optical elements, deriving a plurality of relational expressions that indicate the relationship among the matrix elements of the matrix that indicates the optical characteristics of the measurement target, and solving the relational expressions as simultaneous equations.

Since each matrix element indicates the optical characteristics of the measurement target, the optical characteristics of the measurement target can be measured by calculating the matrix elements.

(3) In any of the optical characteristic measuring apparatuses,

the half-wave plate and the first quarter-wave plate may form a first phase modulation section, and the second quarter-wave plate and the second polarizer may form a second phase modulation section;

the first to Nth conditions may be conditions in which the first phase modulation section is set under first to Lth (L is an integer equal to or larger than two) conditions that differ in at least one of the principal axis directions of the half-wave plate and the first quarter-wave plate and the second phase modulation section is set under first to Mth (M is an integer equal to or larger than two) conditions that differ in a principal axis direction of at least one of the second quarter-wave plate and the second polarizer, and

N=L×M may be satisfied.

(4) In any of the optical characteristic measuring apparatuses, L and M may be integers equal to or larger than four.

(5) In any of the optical characteristic measuring apparatuses, L may be equal to M.

(6) In any of the optical characteristic measuring apparatuses,

when the principal axis directions of the first quarter-wave plate and the second quarter-wave plate are referred to as theta₂ and theta₃, respectively, the optical system set under the first to Nth conditions may be an optical system in which 2theta₂ is a multiple of 180° or an odd-numbered multiple of 90° and 2theta₃ is a multiple of 180° or an odd-numbered multiple of 90°.

This enables the theoretical expression for the light intensity of the measurement light to be simplified, as indicated by expressions (13) to (16) described later. This reduces the calculation load, whereby the calculation speed can be increased. As a result, the measurement speed can be increased.

(7) In any of the optical characteristic measuring apparatuses,

the calculation section may calculate all of the matrix elements of the matrix that indicates the optical characteristics of the measurement target.

The matrix that indicates the optical characteristics of the measurement target may be a Mueller matrix. In the invention, all of the sixteen matrix elements of the Mueller matrix may be calculated.

The matrix that indicates the optical characteristics of the measurement target may be a Jones matrix. In the invention, all of the four matrix elements of the Jones matrix may be calculated.

Note that the optical characteristic measuring apparatus may be configured to calculate only some of the matrix elements of the matrix that indicates the optical characteristics of the measurement target.

(8) In any of the optical characteristic measuring apparatuses,

the light intensity information acquisition section may acquire the light intensity information relating to the measurement light obtained by the optical system in which the half-wave plate, the first quarter-wave plate, the second quarter-wave plate, and the analyzer are rotated successively at a given rotational ratio. According to this configuration, the optical characteristics can be measured using the light intensity information relating to the measurement light obtained by the optical system of which the optical elements are rotated successively. Therefore, the optical characteristics can be measured quickly as compared with the case where the optical elements are rotated and stopped successively.

(9) In any of the optical characteristic measuring apparatuses,

the light intensity information acquisition section may acquire the light intensity information relating to the measurement light obtained by the optical system in which the half-wave plate, the first quarter-wave plate, the second quarter-wave plate, and the analyzer are rotated successively at a disjoint rotational ratio.

This makes it possible to acquire all pieces of data necessary for the measurement.

(10) Any of the optical characteristic measuring apparatuses may further comprise:

first to fourth actuators that drive the half-wave plate, the first quarter-wave plate, the second quarter-wave plate, and the second polarizer;

first to fourth detection sections that detect the principal axis directions of the half-wave plate, the first quarter-wave plate, the second quarter-wave plate, and the second polarizer; and

a control signal generation section chat generates a control signal that controls operations of the first to fourth actuators,

wherein the control signal generation section may generate the control signal based on detection signals from the first to fourth detection sections.

(11) An optical characteristic measuring unit according to the invention comprises any of the above optical characteristic measuring apparatuses.

The optical characteristic measuring unit may be configured to calculate the optical characteristic elements (physical quantities that indicate the optical characteristics of the measurement target) of the measurement target utilizing matrix elements of the matrix (Mueller matrix or Jones matrix) that indicates the optical characteristics of the measurement target. In this case, the optical characteristic measurement unit may be configured to calculate optical characteristic elements of the measurement target such as retardation, depolarization, principal axis direction, angle of rotation, and dichroism.

(12) According to the invention, there is provided an optical characteristic measuring method of measuring the optical characteristics of a measurement target, the optical characteristic measuring method comprising:

a light intensity information acquisition step that acquires light intensity information relating to measurement light modulated by the measurement target and at least five optical elements included in an optical system; and

a calculation step that calculates at least one of matrix elements of a matrix that indicates the optical characteristics of the measurement target based on a theoretical expression for the light intensity of the measurement light and the light intensity information relating to the measurement light,

the at least five optical elements including a first polarizer, a second polarizer, a half-wave plate, a first quarter-wave plate, and a second quarter-wave plate, at least the half-wave plate, the first quarter-wave plate, the second quarter-wave plate, and the second polarizer being rotatable;

the measurement light being obtained by causing light having a predetermined wavelength emitted from a light source to be incident on the measurement target through the first polarizer, the half-wave plate, and the first quarter-wave plate, and causing the light modulated by the measurement target to be incident on a light-receiving section through the second quarter-wave plate and the second polarizer,

the light intensity information acquisition step acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter-wave plate, and the second polarizer; and

the calculation step calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables.

According to the invention, the theoretical expression for the light intensity of the measurement light includes the matrix elements of the matrix that indicates the optical characteristics of the measurement target as variables. The theoretical expression for the light intensity of the measurement light reflects the principal axis directions of the optical elements. Therefore, one relational expression that indicates the relationship among the matrix elements of the matrix that indicates the optical characteristics of the measurement target can be derived by utilizing one piece of light intensity information acquired by the light intensity information acquisition section and the principal axis direction information relating to the optical elements.

Since the acquired light intensity and the coefficient included in the light intensity theoretical expression change when the principal axis directions of the optical elements are changed, the light intensity theoretical expression changes.

Therefore, the matrix elements of the matrix that indicates the optical characteristics of the measurement target can be calculated by appropriately setting the principal axis directions of the optical elements, deriving a plurality of relational expressions that indicate the relationship among the matrix elements of the matrix that indicates the optical characteristics of the measurement target, and solving the relational expressions as simultaneous equations.

In the invention, the light intensity information acquisition step acquires the first light intensity information to the Nth (N is an integer equal to or larger than two) light intensity information (i.e., N pieces of light intensity information). The first light intensity information to the Nth light intensity information indicate the light intensity information relating to the measurement light obtained by the optical system 10 set under the first to Nth conditions, respectively. The first to Nth conditions differ in at least one of the principal axis directions of the optical elements (first and second half-wave plates).

For example, the first light intensity information is acquired using the optical system set under the first condition. The second light intensity information is then acquired using the optical system set under the second condition. N relational expressions including the matrix elements of the matrix that indicates the optical characteristics of the measurement target as variables may be derived by repeating the above process N times.

The matrix elements can be calculated as values by solving the relational expressions with respect to each matrix element. Since each matrix element indicates the optical characteristics of the measurement target, the optical characteristics of the measurement target can be measured by calculating the matrix elements.

According to the invention, since the optical system can be formed using only the rotational optical elements, the optical system can be set and changed accurately and quickly. According to the invention, an optical characteristic measuring method that can accurately and efficiently measure optical characteristics can be provided.

(13) In this optical characteristic measuring method,

the half-wave plate and the first quarter-wave plate may form a first phase modulation section, and the second quarter-wave plate and the second polarizer may form a second phase modulation section;

the first to Nth conditions may be conditions in which the first phase modulation section is set under first to Lth (L is an integer equal to or larger than two) conditions that differ in at least one of the principal axis directions of the half-wave plate and the first quarter-wave plate and the second phase modulation section is set under first to Mth (M is an integer equal to or larger than two) conditions that differ in at least one of the principal axis directions of the second quarter-wave plate and the second polarizer, and

N=L×M may be satisfied.

L and M may be integers equal to or larger than four. L may be equal to M.

(14) In this optical characteristic measuring method,

when the principal axis directions of the first quarter-wave plate and the second quarter-wave plate are referred to as theta₂ and theta₃, respectively, the optical system set under the first to Nth conditions may be an optical system in which 2theta₂ is a multiple of 180° or an odd-numbered multiple of 90° and 2theta₃ is a multiple of 180° or an odd-numbered multiple of 90°.

This enables the theoretical expression for the light intensity of the measurement light to be simplified, as indicated by the expressions (13) to (16) described later. This reduces the calculation load, whereby the calculation speed can be increased. As a result, the measurement speed can be increased.

(15) In this optical characteristic measuring method,

the calculation step may calculate all of the matrix elements of the matrix that indicates the optical characteristics of the measurement target.

The matrix that indicates the optical characteristics of the measurement target may be a Mueller matrix. In the invention, all of the sixteen matrix elements of the Mueller matrix may be calculated.

The matrix that indicates the optical characteristics of the measurement target may be a Jones matrix. In the invention, all of the four matrix elements of the Jones matrix may be calculated.

Note that the optical characteristic measuring apparatus may be configured to calculate only some of the matrix elements of the matrix that indicates the optical characteristics of the measurement target.

(16) In this optical characteristic measuring method,

the light intensity information acquisition step may acquire the light intensity information relating to the measurement light obtained by the optical system in which the half-wave plate, the first quarter-wave plate, the second quarter-wave plate, and the analyzer are rotated successively at a given rotational ratio.

According to this configuration, the optical characteristics can be measured using the light intensity information relating to the measurement light obtained by the optical system of which the optical elements are rotated successively. Therefore, the optical characteristics can be measured quickly as compared with the case where the optical elements are rotated and stopped successively.

(17) In this optical characteristic measuring method,

the light intensity information acquisition step may acquire the light intensity information relating to the measurement light obtained by the optical system in which the half-wave plate, the first quarter-wave plate, the second quarter-wave plate, and the analyzer are rotated successively at a disjoint rotational ratio.

This makes it possible to acquire all pieces of data necessary for the measurement.

### BRIEF DESCRIPTION OF THE DRAWINGS

FIG. 1 is a schematic diagram showing an optical characteristic measuring apparatus.

FIG. 2 is a block diagram showing an optical characteristic measuring apparatus.

FIG. 3 is a diagram illustrative of an optical characteristic measuring apparatus.

FIG. 4 is a diagram illustrative of an optical characteristic measuring apparatus.

FIG. 5 is a flowchart showing a light intensity information acquisition step.

FIG. 6 is a flowchart showing a calculation step.

FIG. 7A is a diagram showing measurement results.

FIG. 7B is a diagram showing measurement results.

FIG. 7C is a diagram showing measurement results.

FIG. 8A is a diagram showing measurement results.

FIG. 8B is a diagram showing measurement results.

FIG. 8C is a diagram showing measurement results.

FIG. 9A is a diagram showing measurement results.

FIG. 9B is a diagram showing measurement results.

FIG. 9C is a diagram showing measurement results.

### BEST MODE FOR CARRYING OUT THE INVENTION

Embodiments of the invention are described below with reference to the drawings.

A measuring apparatus (optical characteristic measuring apparatus) according to one embodiment of the invention measures the optical characteristics of a measurement target.

A measuring apparatus 1 that can calculate at least one of matrix elements of a matrix that indicates the optical characteristics of a sample 100 (i.e., measurement target) is described below as a measuring apparatus according to an embodiment to which the invention is applied.

### (1) DEVICE CONFIGURATION

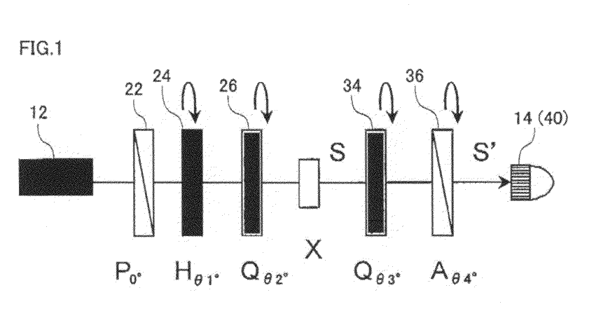

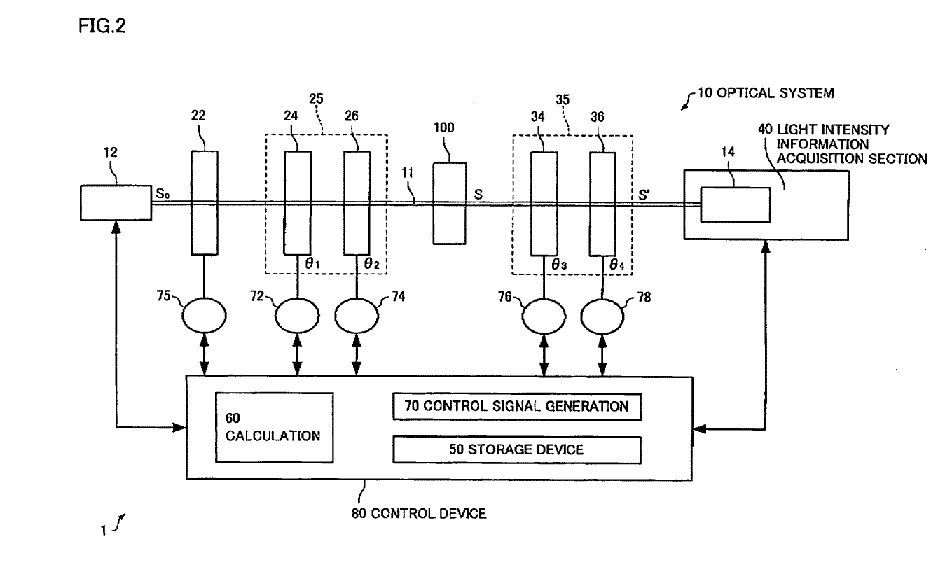

FIGS. 1 and 2 are diagrams illustrative of the configuration of the measuring apparatus 1. FIG. 1 is a schematic diagram showing an optical system 10 (measuring apparatus 1), and FIG. 2 is a block diagram showing the measuring apparatus 1.

The measuring apparatus 1 according to this embodiment measures the optical characteristics of the sample 100 (i.e., measurement target). The measuring apparatus 1 includes the optical system 10, a light intensity information acquisition section 40, and a calculation section 60. The light intensity information acquisition section 40 acquires light intensity information relating to measurement light modulated by an optical element included in the optical system 10 and the sample 100. The calculation section 60 performs a calculation process that calculates the optical characteristics (matrix elements) of the sample 100 based on a theoretical expression for the light intensity of the measurement light and the light intensity information relating to the measurement light. The sample 100 may be a substance that allows light to pass through, or may be a substance that reflects light.

The configuration of the measuring apparatus 1 is described below.

### 1-1: Optical System 10

The optical system 10 includes a light source 12 and a light-receiving section 14. The optical system 10 also includes a polarizer 22, a half-wave plate 24, a first quarter-wave plate 26, a second quarter-wave plate 34, and an analyzer 36 provided in an optical path 11 that connects the light source 12 and the light-receiving section 14. These optical elements are arranged so that light emitted from the light source 12 is incident on the sample 100 through the polarizer 22, the half-wave plate 24, and the first quarter-wave plate 26, and the light modulated by the sample 100 is incident on the light-receiving section 14 through the second quarter-wave plate 34 and the analyzer 36. Each element is described below.

The light source 12 emits light having a predetermined wavelength (wave number). Specifically, the light source 12 may be referred to as a light-emitting device that emits monochromatic light. A laser, an SLD, or the like may be used as the light source 12. The light source 12 may be configured so that the wavelength (wave number) of light emitted from the light source 12 can be changed.

The polarizer 22 is an incident-side polarizer that makes a pair with the analyzer 36 and linearly polarizes light emitted from the light source 12.

The half-wave plate 24 is an optical element that changes the vibration direction of linearly polarized light. The first quarter-wave plate 26 and the second quarter-wave plate 34 are optical elements that change linearly polarized light into circularly polarized light (elliptically polarized light). The half-wave plate 24, the first quarter-wave plate 26, and the second quarter-wave plate 34 are selected corresponding to the wavelength of light emitted from the light source 12.

The analyzer 36 is an exit-side polarizer that linearly polarizes light modulated by the sample 100 (light emitted from the second quarter-wave plate 34). The analyzer 36 makes a pair with the polarizer 22. Specifically, the polarizer 22 may be referred to as a first polarizer, and the analyzer 36 may be referred to as a second polarizer.

The optical system 10 is configured so that the half-wave plate 24, the first quarter-wave plate 26, the second quarter-wave plate 34, and the analyzer 36 can be rotated. The optical system 10 may be configured so that the polarizer 22 can also be rotated. The principal axis directions of these optical elements can be changed by rotating these optical elements. In the optical system 10, the phase of light emitted from the light source 12 is arbitrarily modulated corresponding to the rotational angles of the optical elements.

In the optical system 10, the half-wave plate 24 and the first quarter-wave plate 26 may form a first phase modulation section 25, and the second quarter-wave plate 34 and the analyzer 36 may form a second phase modulation section 35.

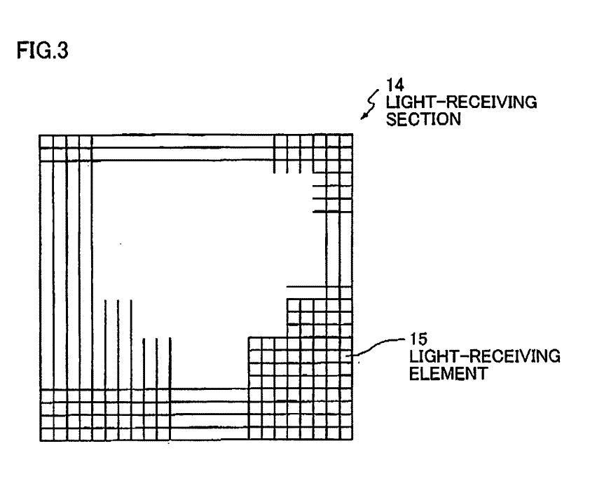

The light-receiving section 14 receives measurement light. The light-receiving section 14 may include a plurality of light-receiving elements 15. As shown in FIG. 3, the light-receiving elements 15 may be arranged in a plane (i.e., two-dimensionally). In this case, the light-receiving elements 15 may form a light-receiving surface. The light intensity information acquisition section 40 may acquire the light intensity information relating to the measurement light incident on each light-receiving element 15. A CCD may be used as the light-receiving section 14, for example.

The optical system 10 may include a beam expander (not shown). The beam expander is an optical element (device) that increases a beam diameter. The beam expander is disposed between the light source 12 and the sample 100. Specifically, the beam expander is disposed on the upstream side of the sample 100 in the optical path 11. This enables light to be applied over a wide range of the sample 100. The optical characteristics can be measured over a wide range of the sample 100 by utilizing the light-receiving section 14 having the two-dimensionally arranged light-receiving elements 15 corresponding to the beam expander. Specifically, the optical characteristics of a broad sample 100 can be measured efficiently. In other words, the sample 100 can be analyzed as a broad surface. Note that the invention may utilize an optical system that does not include the beam expander.

The optical system 10 may include a reflector plate (mirror) (not shown). The optical system 10 can be configured so that the sample 100 can be disposed horizontally by utilizing the reflector plate. Specifically, the measuring apparatus 1 may be formed in the form of a microscope by utilizing the reflector plate. Note that the measuring apparatus 1 may be formed in the form of a microscope without utilizing the reflector plate.

As shown in FIGS. 1 and 2, the optical system 10 may be configured so that light that has passed through the sample 100 is incident on the second quarter-wave plate 34 (second phase modulation section 35). Note that the optical system 10 may be configured so that light reflected by the sample 100 is incident on the second quarter-wave plate 34 (second phase modulation section 35) (not shown).

### 1-2: Light Intensity Information Acquisition Section 40

The light intensity information acquisition section 40 acquires the light intensity information relating to the measurement light. Specifically, the light intensity information acquisition section 40 acquires the light intensity information relating to light (measurement light) modulated by the optical elements (polarizer 22, half-wave plate 24, first quarter-wave plate 26, second quarter-wave plate 34, and analyzer 36) included in the optical system 10 and the sample 100. Specifically, the light intensity information acquisition section 40 acquires the light intensity information relating to light (measurement light) received by the light-receiving section 14. The light-receiving section 14 may form part of the light intensity information acquisition section 40.

In the measuring apparatus 1, the light intensity information acquisition section 40 acquires the light intensity information relating to first measurement light to Nth (N is an integer equal to or larger than two) measurement light (i.e., a plurality of types of measurement light) obtained by the optical system 10 set under first to Nth conditions (principal axis direction conditions) that differ in at least one of principal axis directions of the half-wave plate 24, the first quarter-wave plate 26, the second quarter-wave plate 34, and the analyzer 36.

Specifically, the light intensity information acquisition section 40 acquires first light intensity information to Nth (N is an integer equal to or larger than two) light intensity information (i.e., N pieces of light intensity information). The first light intensity information to the Nth light intensity information refer to the light intensity information relating to the measurement light obtained by the optical system 10 set under the first to Nth conditions (principal axis direction conditions), respectively. The optical system 10 set under the first to Nth conditions (principal axis direction conditions) differs in at least one of the principal axis directions of the optical elements (half-wave plate 24, first quarter-wave plate 26, second quarter-wave plate 34, and analyzer 36).

The first to Nth principal axis direction conditions may be conditions in which the first phase modulation section 25 is set under one of first to Lth (L is an integer equal to or larger than two) conditions that differ in at least one of the principal axis directions of the half-wave plate 24 and the first quarter-wave plate 26 and the second phase modulation section 35 is set under one of first to Mth (M is an integer equal to or larger than two) conditions that differ in at least one of the principal axis directions of the second quarter-wave plate 34 and the analyzer 36. For example, the light intensity information acquisition section 40 acquires M pieces of light intensity information relating to the measurement light by sequentially setting the second phase modulation section 35 under the first to Mth conditions in a state in which the first phase modulation section 25 is set under the first condition. The light intensity information acquisition section 40 then acquires M pieces of light intensity information relating to the measurement light by sequentially setting the second phase modulation section 35 under the first to Mth conditions in a state in which the first phase modulation section 25 is set under the second condition. L×M pieces of light intensity information relating to the measurement light may be acquired by repeating the above-described operation. In this case, N=L×M is satisfied. L and M may be integers equal to or larger than four. L may be equal to M.

The principal axis direction of the polarizer 22 may be the same or different under the first to Nth principal axis direction conditions.

A plurality of pieces of light intensity information acquired by the light intensity information acquisition section 40 may be stored in a storage device 50 provided in a control device 80. The storage device 50 may store the plurality of pieces of light intensity information corresponding to the setting conditions (i.e., the principal axis directions of the polarizer 22, the half-wave plate 24, the first quarter-wave plate 26, the second quarter-wave plate 34, and the analyzer 36) for the optical system 10. For example, the storage device 50 may store the first light intensity information to the Nth light intensity information corresponding to the principal axis directions of the optical elements under the first to Nth conditions.

### 1-3: Calculation Section 60

The calculation section 60 performs a calculation process that calculates matrix elements of a matrix that indicates the optical characteristics of the measurement target (sample 100) based on the theoretical expression for the light intensity of the measurement light and the light intensity information relating to the measurement light. The theoretical expression for the light intensity of the measurement light may include matrix elements of a matrix that indicates the optical characteristics of the sample 100 as variables (described later in detail). Coefficients involved in the theoretical expression for the light intensity of the measurement light change corresponding to the principal axis directions of the optical elements of the optical system 10. Therefore, a plurality of relational expressions that indicate the relationship between a plurality of matrix elements can be derived and the represent can be derived by acquiring a plurality of pieces of light intensity information relating to the measurement light obtained by the optical system 10 that differ in principal axis directions of the optical elements and applying the light intensity theoretical expression. The matrix elements can be calculated as values by solving the relational expressions with respect to each matrix element.

If the matrix elements of the matrix that indicates the optical characteristics of the sample 100 can be calculated, the optical characteristics (e.g., retardation, principal axis direction, angle of rotation, dichroism, or depolarization) of the sample 100 can be calculated (measured) utilizing the matrix elements.

### 1-4: Driver/Detection Section

The measuring apparatus 1 further includes first to fourth driver/detection sections 72 to 78 (72, 74, 76, and 78). The first to fourth driver/detection sections 72 to 78 function as driver sections that respectively rotate the half-wave plate 24, the first quarter-wave plate 26, the second quarter-wave plate 34, and the analyzer 36, and function as detection sections (sensors) that respectively detect the principal axis directions of the half-wave plate 24, the first quarter-wave plate 26, the second quarter-wave plate 34, and the analyzer 36.

The measuring apparatus 1 may further include another driver/detection section 75. The driver/detection section 75 functions as a driver section that rotates the polarizer 22, and functions as a detection section (sensor) that detects the principal axis direction of the polarizer 22. The measuring apparatus 1 may be configured so that the first to fourth driver/detection sections 72 to 78 continuously rotate the optical elements at a given rotational ratio.

The measuring apparatus 1 may further include a control signal generation section 70 that controls the operations of the first to fourth driver/detection sections 72 to 78. For example, the control signal generation section 70 may generate a control signal based on a detection signal from the detection section to control the operation of the driver section.

### 1-5: Control Device 80

The measuring apparatus 1 may include the control device 80. The control device 80 may have a function of controlling the operation of the measuring apparatus 1. Specifically, the control device 80 may control the first to fourth driver/detection sections 72 to 78 to set the principal axis directions of the optical elements (polarizer 22, half-wave plate 24, first quarter-wave plate 26, second quarter-wave plate 34, and analyzer 36), control the light-emitting operation of the light source 12, and control the operations of the light intensity information acquisition section 40 and the calculation section 60.

The control device 80 may include the storage device 50 and the calculation section 60. The storage device 50 has a function of temporarily storing various types of data. The storage device 50 may store the light intensity information relating to the measurement light corresponding to the principal axis direction information (first principal axis direction information to Nth principal axis direction information) relating to the optical elements (polarizer 22, half-wave plate 24, first quarter-wave plate 26, second quarter-wave plate 34, and analyzer 36), for example.

The control device 80 may include the control signal generation section 70. The control device 80 may further include a synchronization control section. The synchronization control section synchronizes rotations of the half-wave plate 24, the first quarter-wave plate 26, the second quarter-wave plate 34, and the analyzer 36 when continuously rotating the half-wave plate 24, the first quarter-wave plate 26, the second quarter-wave plate 34, and the analyzer 36 to acquire the light intensity information. The synchronization control section may generate a synchronization control signal based on the principal axis direction information relating to the half-wave plate 24, the first quarter-wave plate 26, the second quarter-wave plate 34, and the analyzer 36 to control the operation of the driver section.

The measuring apparatus 1 can perform a process utilizing a computer using the control device 80 (calculation section 60). The term “computer” used herein refers to a physical device (system) that includes a processor (processing section: CPU or the like), a memory (storage section), an input device, and an output device as basic elements.

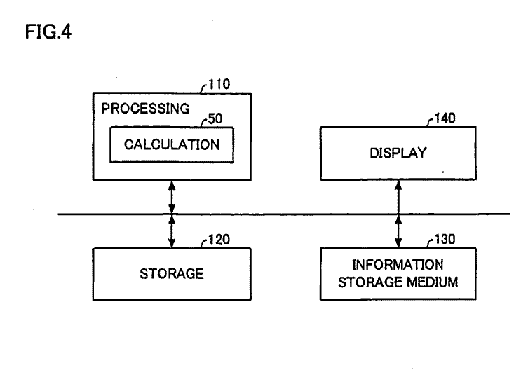

FIG. 4 shows an example of functional blocks of a calculation system that forms the measuring apparatus 1.

A processing section 110 performs various processes according to this embodiment based on a program (data) stored in an information storage medium 130. Specifically, a program that causes a computer to function as each section according to this embodiment (i.e., a program that causes a computer to execute the process of each section) is stored in the information storage medium 130.

The function of the processing section 110 may be implemented by hardware such as a processor (e.g., CPU or DSP) or ASIC (e.g., gate array), or a program.

A storage section 120 serves as a work area for the processing section and the like. The function of the storage section 120 may be implemented by a RAM or the like.

The information storage medium 130 (computer-readable medium) stores a program, data, and the like. The function of the information storage medium 130 may be implemented by an optical disk (CD or DVD), a magneto-optical disk (MO), a magnetic disk, a hard disk, a magnetic tape, a memory (ROM), or the like.

The rotational ratio of the first and second half-wave plates 24 and 28 may be set and the operation of the light source 12 may be controlled based on a program stored in the information storage medium 130.

A display section 140 may have a function of displaying information obtained by the measuring apparatus as an image. As the display section 140, known hardware may be applied.

### (2) OPTICAL CHARACTERISTIC MEASUREMENT PRINCIPLE

The optical characteristic measurement principle employed in the optical characteristic measuring apparatus according to this embodiment is described below. In this embodiment, the optical characteristic measurement principle is described taking an example in which the matrix that indicates the optical characteristics of the measurement target (sample 100) is a Mueller matrix.

### 2-1: Theoretical Expression for Light Intensity of Measurement Light

The Stokes parameter S₀ of light (emitted light) emitted from the light source 12, the Mueller matrix Pₜₕₑₜₐ of the polarizer 22, the Mueller matrix Hₜₕₑₜₐ₁ of the half-wave plate 24, the Mueller matrix Qₜₕₑₜₐ₂ of the first quarter-wave plate 26, and the Mueller matrix X of the sample 100 are expressed as follows.

$$\begin{matrix}{S}_{0} = {I}_{0} [ \begin{matrix}1 \\ 0 \\ 0 \\ 0\end{matrix} ] & ( 1 ) \\ {P}_{θ} = [ \begin{matrix}1 & cos 2 θ & sin 2 θ & 0 \\ cos 2 θ & {cos}^{2} 2 θ & sin 2 θcos2θ & 0 \\ sin 2 θ & sin 2 θcos2θ & {sin}^{2} 2 θ & 0 \\ 0 & 0 & 0 & 0\end{matrix} ] & ( 2 ) \\ {H}_{θ 1} = [ \begin{matrix}1 & 0 & 0 & 0 \\ 0 & cos 4 {θ}_{1} & sin 4 {θ}_{1} & 0 \\ 0 & sin 4 {θ}_{1} & - cos 4 {θ}_{1} & 0 \\ 0 & 0 & 0 & - 1\end{matrix} ] & ( 3 ) \\ {Q}_{θ 2} = [ \begin{matrix}1 & 0 & 0 & 0 \\ 0 & {cos}^{2} 2 {θ}_{2} & sin 2 {θ}_{2} \cdot cos 2 {θ}_{2} & - sin 2 {θ}_{2} \\ 0 & sin 2 {θ}_{2} \cdot sin 2 {θ}_{2} & {sin}^{2} 2 {θ}_{2} & cos 2 {θ}_{2} \\ 0 & sin 2 {θ}_{2} & - cos 2 {θ}_{2} & 0\end{matrix} ] & ( 4 ) \\ X = [ \begin{matrix}{m}_{00} & {m}_{01} & {m}_{02} & {m}_{03} \\ {m}_{10} & {m}_{11} & {m}_{12} & {m}_{13} \\ {m}_{20} & {m}_{21} & {m}_{22} & {m}_{23} \\ {m}_{30} & {m}_{31} & {m}_{32} & {m}_{33}\end{matrix} ] & ( 5 )\end{matrix}$$

where, theta indicates the principal axis direction of the polarizer 22, theta₁ indicates the principal axis direction of the half-wave plate 24, and theta₂ indicates the principal axis direction of the first quarter-wave plate 26. m₀₀ to m₃₃ indicate the matrix elements of the Mueller matrix that indicates the optical characteristics of the sample 100.

The Stokes parameter S of the emitted light modulated by the polarizer 22, the half-wave plate 24, the first quarter-wave plate 26, and the sample 100 is expressed as follows utilizing the above matrix expressions,

$$S = X \cdot {Q}_{θ 2} \cdot {H}_{01} \cdot {P}_{θ} \cdot {S}_{0} \\ = [ \begin{matrix}{m}_{00} + {m}_{01} cos 2 {θ}_{2} cos δ + {m}_{02} sin 2 {θ}_{2} cos δ - {m}_{03} sin δ \\ {m}_{10} + {m}_{11} cos 2 {θ}_{2} cos δ + {m}_{12} sin 2 {θ}_{2} cos δ - {m}_{13} sin δ \\ {m}_{20} + {m}_{21} cos 2 {θ}_{2} cos δ + {m}_{22} sin 2 {θ}_{2} cos δ - {m}_{23} sin δ \\ {m}_{30} + {m}_{31} cos 2 {θ}_{2} cos δ + {m}_{32} sin 2 {θ}_{2} cos δ - {m}_{33} sin δ\end{matrix} ] = [ \begin{matrix}{S}_{0} \\ {S}_{1} \\ {S}_{2} \\ {S}_{3}\end{matrix} ] \qquad ( 6 )$$

where,

$$δ = 4 ( {θ}_{1} - \frac{1}{2} θ ) - 2 {θ}_{2} \qquad ( 7 )$$

S₀ to S₃ indicate components (elements) of the Stokes parameter of light emitted from the sample 100.

The Stokes parameter Qₜₕₑₜₐ₃ of the second quarter-wave plate 34 and the Stokes parameter Aₜₕₑₜₐ₄ of the analyzer 36 can be expressed as follows.

$$\begin{matrix}{Q}_{θ3} = [ \begin{matrix}1 & 0 & 0 & 0 \\ 0 & {cos}^{2} 2 {θ}_{3} & sin 2 {θ}_{3} \cdot cos 2 {θ}_{3} & - sin 2 {θ}_{3} \\ 0 & sin 2 {θ}_{3} \cdot cos 2 {θ}_{3} & {sin}^{2} 2 {θ}_{3} & cos 2 {θ}_{3} \\ 0 & sin 2 {θ}_{3} & - cos 2 {θ}_{3} & 0\end{matrix} ] & ( 8 ) \\ {A}_{θ 4} = [ \begin{matrix}1 & cos 2 {θ}_{4} & sin 2 {θ}_{4} & 0 \\ cos 2 {θ}_{4} & {cos}^{2} 2 {θ}_{4} & sin 2 θcos 2 {θ}_{4} & 0 \\ sin 2 {θ}_{4} & sin 2 θcos 2 {θ}_{4} & {sin}^{2} 2 {θ}_{4} & 0 \\ 0 & 0 & 0 & 0\end{matrix} ] & ( 9 )\end{matrix}$$

Therefore, the Stokes parameter S′ of light (measurement light) that has passed through the analyzer 36 and is incident on the light-receiving section 14 can be expressed as follows.

S′=A_{θ4}·Q_{θ3}·S (10)

Therefore, a theoretical expression for light intensity I of the measurement light can be expressed as follows from the first component of Stokes parameter S′.

$$\begin{matrix}I = {S}_{0} + {S}_{1} cos 2 {θ}_{3} cos ( 2 {θ}_{3} - 2 {θ}_{4} ) + \\ {S}_{2} sin {2}_{3} cos ( 2 {θ}_{3} - 2 {θ}_{4} ) - {S}_{3} sin ( 2 {θ}_{3} - 2 {θ}_{4} ) \\ = {S}_{0} + cos {δ}^{′} ( {S}_{1} cos 2 {θ}_{3} + {S}_{2} sin 2 {θ}_{3} ) - {S}_{3} sin {δ}^{′}\end{matrix} \qquad ( 11 )$$

where,

δ′=2θ₃−2θ₄ (12)

### 2-2: Calculation Principle for Matrix Elements of Mueller Matrix of Sample 100

As is clear from the expression (11), the theoretical expression for the light intensity of the measurement light is expressed by S₀ to S₃, theta₃, and theta₄. As is clear from the expression (6) (and the expression (7)), S₀ to S₃ are expressed by m₀₀ to m₃₃, theta, theta₁, and theta₂.

Specifically, when using the optical system 10, the theoretical expression for the light intensity of the measurement light is expressed by m₀₀ to m₃₃ (i.e., the matrix elements of the Mueller matrix of the sample 100) and theta, theta₁, theta₂, theta₃, and theta₄ (i.e., the principal axis directions of the optical elements of the optical system 10). theta to theta₄ can be detected by the driver/detection sections. According to the optical system 10, the theoretical expression for the light intensity of the measurement light can be expressed by an expression having m₀₀ to m₃₃ as unknown quantities.

Since the theoretical expression for the light intensity of the measurement light includes theta to theta₄, theoretical expressions that differ in coefficient are derived by changing the principal axis direction conditions for the optical elements of the optical system 10. Since m₀₀ to m₃₃ are value specific to the measurement target (sample 100), m₀₀ to m₃₃ do not change even if the principal axis directions of the optical elements of the optical system 10 are changed.

Therefore, N relational expressions that indicate the relationship among the matrix elements m₀₀ to m₃₃ of the Mueller matrix of the sample 100 can be derived by substituting the light intensity of each of the first measurement light to Nth measurement light obtained by the optical system 10 set under the first to Nth conditions that differ in at least one of the principal axis directions of the optical elements into the expression (6) and the expression (11) corresponding to the first to Nth principal axis direction conditions.

The matrix elements of the Mueller matrix of the sample 100 can be calculated as values by solving the N relational expressions as simultaneous equations.

### (3) OPTICAL CHARACTERISTIC MEASUREMENT STEP

An optical characteristic measurement step using the optical characteristic measuring apparatus according to this embodiment is described below.

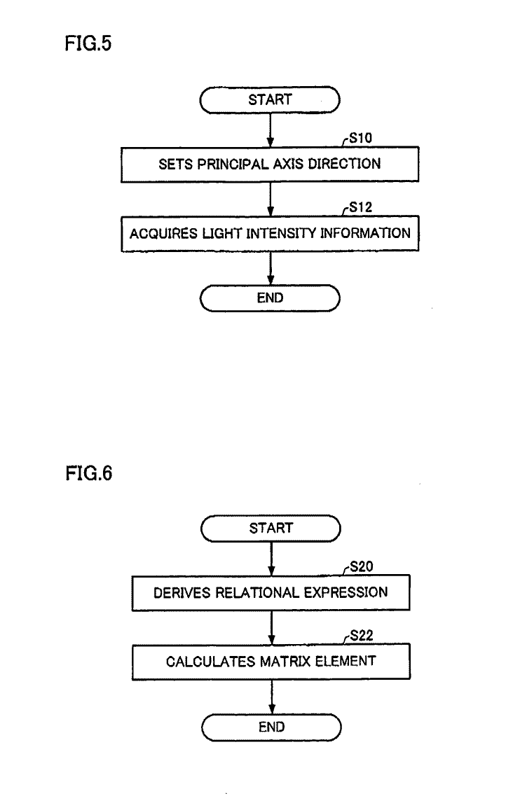

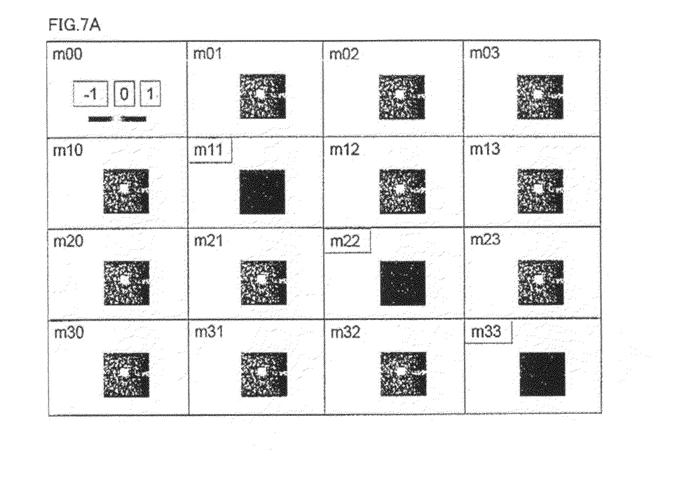

FIGS. 5 and 6 show flowcharts illustrative of the operation of the optical characteristic measuring apparatus according to this embodiment.

### 3-1: Light Intensity Information Acquisition Step

FIG. 5 shows a flowchart illustrative of a light intensity information acquisition step.

In the light intensity information acquisition step, the principal axis directions of the optical elements of the optical system 10 are set (step S10).

Light is then emitted from the light source 12, and the light-receiving section 14 receives measurement light modulated by the optical elements and the sample 100. The light intensity information acquisition section 40 acquires the light intensity information relating to the measurement light received by the light-receiving section 14 (step S12).

The sample 100 may be provided in the optical path 11 of the optical system 10 before the step S12. This step may be performed before or after setting the principal axis directions of the optical elements.

The measuring apparatus 1 acquires the light intensity information relating to first measurement light to Nth measurement light by these steps. Note that the light intensity information relating to the first measurement light to the Nth measurement light refers to the light intensity information relating to the measurement light obtained by the optical system 10 that differs in at least one of the principal axis directions of the half-wave plate 24, the first quarter-wave plate 26, the second quarter-wave plate 34, and the analyzer 36. In the light intensity information acquisition step, the steps S10 and S12 are repeated a plurality of times while changing the principal axis direction of the optical element (at least one of the half-wave plate 24, the first quarter-wave plate 2, the second quarter-wave plate 34, and the analyzer 36).

Specifically, the measuring apparatus 1 acquires the first light intensity information in a state in which the optical system 10 (i.e., the principal axis directions of the optical elements) are set under the first condition. The measuring apparatus 1 stores the first light intensity information in the storage device 50 corresponding to the first condition (principal axis direction information). The measuring apparatus 1 then acquires the second light intensity information in a state in which the optical system 10 is set under the second condition, and stores the second light intensity information in the storage device 50 corresponding to the second condition. The measuring apparatus 1 repeats the above-described operation to acquire N pieces of principal axis direction information and N pieces of light intensity information, and stores the N pieces of principal axis direction information and the N pieces of light intensity information in the storage device 50 while associating the respective pieces of information.

The principal axis directions of the optical elements of the optical system 10 may be set (changed) by an actuator. The principal axis direction information relating to the optical elements of the optical system may be detected by the detection section, or may be information programmed in advance.

### 3-2: Calculation Step

FIG. 6 shows a flowchart illustrative of a calculation step. In the calculation step, the optical characteristics of the sample 100 are calculated based on the light intensity information relating to the measurement light acquired by the light intensity information acquisition step and the theoretical expression for the measurement light.

In the calculation step, the light intensity information and the principal axis direction information relating to the optical elements are substituted into the theoretical expression for the measurement light (e.g., the expressions (6) and (11)) to derive relational expressions that indicate the relationship among the matrix elements of the matrix (i.e., the matrix elements of the Mueller matrix) that indicates the optical characteristics of the sample 100 and the light intensity of the measurement light (step S20).

Note that one relational expression that indicates the relationship among the matrix elements of the matrix (i.e., the matrix elements of the Mueller matrix) that indicates the optical characteristics of the sample 100 can be derived from one piece of light intensity information and one piece of principal axis direction information. Specifically, a plurality of relational expressions that indicate the relationship among the matrix elements of the matrix (i.e., the matrix elements of the Mueller matrix) that indicates the optical characteristics of the sample 100 can be derived by utilizing N pieces of light intensity information and N pieces of principal axis direction information corresponding to the N pieces of light intensity information.

The matrix elements of the matrix (i.e., the matrix elements of the Mueller matrix) that indicates the optical characteristics of the sample 100 is are calculated by solving the relational expressions (step S22).

### (4) SPECIFIC EXAMPLE OF CALCULATIONS OF MATRIX ELEMENTS OF MATRIX (MATRIX ELEMENTS OF MUELLER MATRIX) THAT INDICATES OPTICAL CHARACTERISTICS OF SAMPLE 100

A specific example of calculations of the matrix elements of the Mueller matrix of the sample 100 is described below.

4-1: Light Intensity Theoretical Expression Used in this Example

The theoretical expression for the light intensity of the measurement light is shown by the expression (11), as described above. The expression (11) can be transformed as follows by substituting 0° or 45° for theta₃ in the expression (11).

I(θ₃=0°)=S₀+S₁ cos δ′−S₃ sin δ′ (13)

I(θ₃=45°)=S₀+S₂ cos δ′=S₃ sin δ′ (14)

Likewise, the expression (6) can be transformed as follows by substituting 0° or 45° for theta₃ in the expression (6).

S₁(θ₂=0°)=mᵢ₀+mᵢ₁ cos δ−mᵢ₃ sin δ′ (15)

S₁(θ₂=45°)=mᵢ₀+mᵢ₂ cos δ−mᵢ₃ sin δ (16)

where, i is 0, 1, 2, or 3.

In this example, the matrix elements of the Mueller matrix of the sample 100 are calculated by utilizing these expressions.

### 4-2: Optical System Principal Axis Direction Condition

In this example, the principal axis directions of the optical elements (half-wave plate 24, first quarter-wave plate 26, second quarter-wave plate 34, and analyzer 36) were set as shown in Table 1 to acquire sixteen pieces of light intensity information (I(0) to I(15)). The principal axis direction of the polarizer 22 was set at 0°.

TABLE 1

| θ1 | θ2 | δ | θ3 | θ4 | δ′ | |
|---|---|---|---|---|---|---|
| 0 | 0 | 0 | 0 | 0 | 0 | I(0) |
| 22.5 | 0 | 90 | 0 | 0 | 0 | I(1) |
| 67.5 | 45 | 180 | 0 | 0 | 0 | I(2) |
| 90 | 45 | 270 | 0 | 0 | 0 | I(3) |
| 0 | 0 | 0 | 0 | −45 | 90 | I(4) |
| 22.5 | 0 | 90 | 0 | −45 | 90 | I(5) |
| 67.5 | 45 | 180 | 0 | −45 | 90 | I(6) |
| 90 | 45 | 270 | 0 | −45 | 90 | I(7) |
| 0 | 0 | 0 | 45 | −45 | 180 | I(8) |
| 22.5 | 0 | 90 | 45 | −45 | 180 | I(9) |
| 67.5 | 45 | 180 | 45 | −45 | 180 | I(10) |
| 90 | 45 | 270 | 45 | −45 | 180 | I(11) |
| 0 | 0 | 0 | 45 | −90 | 270 | I(12) |
| 22.5 | 0 | 90 | 45 | −90 | 270 | I(13) |
| 67.5 | 45 | 180 | 45 | −90 | 270 | I(14) |
| 90 | 45 | 270 | 45 | −90 | 270 | I(15) |

### 4-3: Calculation Step

The light intensity information I(0) and delta′=0° or the light intensity information I(4) and delta′=90° are substituted into the expression (13), and the light intensity information I(8) and delta′=180° or the light intensity information I(12) and delta′=270° are substituted into the expression (14). The following four expressions are thus obtained.

I(0)=S₀+S₁ (17)

I(4)=S₀−S₃ (18)

I(8)=S₀−S₂ (19)

I(12)=S₀+S₃ (20)

The Stokes parameters S₀ to S₃ can be calculated as follows by solving the expressions (17) to (20).

$$\begin{matrix}{S}_{0} = \frac{I ( 4 ) + I ( 12 )}{2} & ( 21 ) \\ {S}_{1} = I ( 0 ) - \frac{I ( 4 ) + I ( 12 )}{2} & ( 22 ) \\ {S}_{2} = - I ( 8 ) + \frac{I ( 4 ) + I ( 12 )}{2} & ( 23 ) \\ {S}_{3} = \frac{- I ( 4 ) + I ( 12 )}{2} & ( 24 )\end{matrix}$$

As shown in Table 1, the light intensities I(0), I(4), I(8), and I(12) are measurement light intensities when delta is 0°. Therefore, the Stokes parameters S₀ to S₃ when delta is 0° are calculated by the above steps.

The above calculations are performed for the light intensity information I(1), I(5), I(9), and I(13), the light intensity information I(2), I(6), I(10), and I(14), and the light intensity information I(3), I(7), I(11), and I(15) to calculate the Stokes parameters S₀ to S₃ when delta is 90°, 180°, or 270°. The calculation results are shown in Table 2.

TABLE 2
${S}_{0} ( {θ}_{2} = 0 , δ = 0 ) = \frac{I ( 4 ) + I ( 12 )}{2}$
${S}_{1} ( {θ}_{2} = 0 , δ = 0 ) = I ( 0 ) - \frac{I ( 4 ) + I ( 12 )}{2}$
${S}_{2} ( {θ}_{2} = 0 , δ = 0 ) = - I ( 8 ) + \frac{I ( 4 ) + I ( 12 )}{2}$
${S}_{3} ( {θ}_{2} = o , δ = 0 ) = \frac{- I ( 4 ) + I ( 12 )}{2}$
${S}_{0} ( {θ}_{2} = 0 , δ = 90 ) = \frac{I ( 5 ) + I ( 13 )}{2}$
${S}_{1} ( {θ}_{2} = 0 , δ = 90 ) = I ( 1 ) - \frac{I ( 5 ) + I ( 13 )}{2}$
${S}_{2} ( {θ}_{2} = 0 , δ = 90 ) = - I ( 9 ) + \frac{I ( 5 ) + I ( 13 )}{2}$
${S}_{3} ( {θ}_{2} = 0 , δ = 90 ) = \frac{- I ( 5 ) + I ( 13 )}{2}$
${S}_{0} ( {θ}_{2} = 45 , δ = 180 ) = \frac{I ( 6 ) + I ( 14 )}{2}$
${S}_{1} ( {θ}_{2} = 45 , δ = 180 ) = I ( 2 ) - \frac{I ( 6 ) + I ( 14 )}{2}$
${S}_{2} ( {θ}_{2} = 45 , δ = 180 ) = - I ( 10 ) + \frac{I ( 6 ) + I ( 14 )}{2}$
${S}_{3} ( {θ}_{2} = 45 , δ = 180 ) = \frac{- I ( 6 ) + I ( 14 )}{2}$
${S}_{0} ( {θ}_{2} = 45 , δ = 270 ) = \frac{I ( 7 ) + I ( 15 )}{2}$
${S}_{1} ( {θ}_{2} = 45 , δ = 270 ) = I ( 3 ) - \frac{I ( 7 ) + I ( 15 )}{2}$
${S}_{2} ( {θ}_{2} = 45 , δ = 270 ) = - I ( 11 ) + \frac{I ( 7 ) + I ( 15 )}{2}$
${S}_{3} ( {θ}_{2} = 45 , δ = 270 ) = \frac{- I ( 7 ) + I ( 15 )}{2}$

Table 2 can be rewritten as follows.

TABLE 3

| | δ = 0 | δ = 90 | δ = 180 | δ = 270 |
|---|---|---|---|---|
| | (θ₂ = 0°) | (θ₂ = 0°) | (θ₂ = 45°) | (θ₂ = 45°) |
| S₀ | ${S}_{00} = \frac{I ( 4 ) + I ( 12 )}{2}$ | ${S}_{01} = \frac{I ( 5 ) + I ( 13 )}{2}$ | ${S}_{02} = \frac{I ( 6 ) + I ( 14 )}{2}$ | ${S}_{03} = \frac{I ( 7 ) + I ( 15 )}{2}$ |
| S₁ | ${S}_{10} = I ( 0 ) - \frac{I ( 4 ) + I ( 12 )}{2}$ | ${S}_{11} = I ( 1 ) - \frac{I ( 5 ) + I ( 13 )}{2}$ | ${S}_{12} = I ( 2 ) - \frac{I ( 6 ) + I ( 14 )}{2}$ | ${S}_{13} = I ( 3 ) - \frac{I ( 7 ) + I ( 15 )}{2}$ |
| S₂ | ${S}_{20} = - I ( 8 ) + \frac{I ( 4 ) + I ( 12 )}{2}$ | ${S}_{21} = - I ( 9 ) + \frac{I ( 5 ) + I ( 13 )}{2}$ | ${S}_{22} = - I ( 10 ) + \frac{I ( 6 ) + I ( 14 )}{2}$ | ${S}_{23} = - I ( 11 ) + \frac{I ( 7 ) + I ( 15 )}{2}$ |
| S₃ | ${S}_{30} = \frac{- I ( 4 ) + I ( 12 )}{2}$ | ${S}_{31} = \frac{- I ( 5 ) + I ( 13 )}{2}$ | ${S}_{32} = \frac{- I ( 6 ) + I ( 14 )}{2}$ | ${S}_{33} = \frac{- I ( 7 ) + I ( 15 )}{2}$ |

The values shown in Table 3 are substituted into the expressions (15) and (16).

For example, i is set at zero in the expressions (15) and (16). delta=0° and the corresponding Stokes parameter S₀ (S₀₀ in Table 3) or delta=90° and the corresponding Stokes parameter S₀ (S₁₀ in Table 3) are substituted into the expression (15). delta=180° and the corresponding Stokes parameter S₀ (S₂₀ in Table 3) or delta=270° and the corresponding Stokes parameter S₀ (S₃₀ in Table 3) are substituted into the expression (16). The following four expressions are thus obtained.

S₀₀=m₀₀+m₀₁ (25)

S₀₁=m₀₀−m₀₃ (26)

S₀₂=m₀₀−m₀₂ (27)

S₀₃=m₀₀+m₀₃ (28)

The matrix elements m₀₀ to m₀₃ can be calculated as follows by solving the expressions (25) to (28).

$$\begin{matrix}{m}_{00} = \frac{{S}_{01} + {S}_{03}}{2} & ( 29 ) \\ {m}_{01} = {S}_{00} - \frac{{S}_{01} + {S}_{03}}{2} & ( 30 ) \\ {m}_{02} = \frac{{S}_{01} + {S}_{03}}{2} - {S}_{02} & ( 31 ) \\ {m}_{03} = \frac{- {S}_{01} + {S}_{03}}{2} & ( 32 )\end{matrix}$$

A similar step is performed for the Stokes parameters Sᵢ, S₂, and S₃ to calculate the matrix elements m₁₀ to m₁₃, m₂₀ to m₂₃, and m₃₀ to m₃₃, respectively. The calculation results are shown in Table 4.

TABLE 4

| | | | |
|---|---|---|---|
| ${m}_{00} = \frac{{S}_{01} + {S}_{03}}{2}$ | ${m}_{01} = {S}_{00} - \frac{{S}_{01} + {S}_{03}}{2}$ | ${m}_{02} = - {S}_{02} - \frac{{S}_{01} + {S}_{03}}{2}$ | ${m}_{03} = \frac{- {S}_{01} + {S}_{03}}{2}$ |
| ${m}_{10} = \frac{{S}_{11} + {S}_{13}}{2}$ | ${m}_{11} = {S}_{10} - \frac{{S}_{11} + {S}_{13}}{2}$ | ${m}_{12} = - {S}_{12} - \frac{{S}_{11} + {S}_{13}}{2}$ | ${m}_{13} = \frac{- {S}_{11} + {S}_{13}}{2}$ |
| ${m}_{20} = \frac{{S}_{21} + {S}_{23}}{2}$ | ${m}_{21} = {S}_{20} - \frac{{S}_{21} + {S}_{23}}{2}$ | ${m}_{22} = - {S}_{22} - \frac{{S}_{21} + {S}_{23}}{2}$ | ${m}_{23} = \frac{- {S}_{21} + {S}_{23}}{2}$ |
| ${m}_{30} = \frac{{S}_{31} + {S}_{33}}{2}$ | ${m}_{31} = {S}_{30} - \frac{{S}_{31} + {S}_{33}}{2}$ | ${m}_{32} = - {S}_{32} - \frac{{S}_{31} + {S}_{33}}{2}$ | ${m}_{33} = \frac{- {S}_{31} + {S}_{33}}{2}$ |

All of the matrix elements of the Mueller matrix that indicates the optical characteristics of the sample 100 can be calculated by the above-described step. In particular, since this method uses simple calculations so that the calculation load is reduced, a high-speed calculation process can be implemented.

Note that the measuring apparatus according to the invention need not necessarily calculate all of the sixteen matrix elements of the Mueller matrix. Specifically, the measuring apparatus 1 may calculate only necessary matrix elements of the sixteen matrix elements of the Mueller matrix.

This example has been described taking an example in which theta₂=0° or 45° and theta₃=0° or 45°. Note that the values for theta₂ and theta₃ which may be applied to this example are not limited thereto. For example, the light intensity information relating to the measurement light may be acquired using the optical system 10 in which the principal axis direction of the first quarter-wave plate 26 is set so that 2theta₂ is a multiple of 180° or an odd-numbered multiple of 90° and the principal axis direction of the second quarter-wave plate 34 is set so that 2theta₃ is a multiple of 180° or an odd-numbered multiple of 90°, and the matrix elements may be calculated. When the optical system 10 satisfies the above condition, the expressions (6) and (11) can be simplified. Therefore, the calculation load can be reduced.

### (5) INDUSTRIAL APPLICABILITY

As described above, the measuring apparatus according to this embodiment can easily, conveniently, and quickly calculate the sixteen matrix elements of the Mueller matrix that indicates the optical characteristics of the sample 100 (i.e., measurement target).

Various optical characteristics (physical quantities that indicate the optical characteristics) of the sample 100 can be determined by calculating all of the sixteen matrix elements of the Mueller matrix that indicates the optical characteristics of the sample 100 (i.e., measurement target). Specific examples of the optical characteristics are given below.

### 5-1: Depolarization

The depolarization of the sample 100 is expressed as follows.

$$Dep ( X ) = 1 - \frac{\sqrt{( {\sum }_{i , j} {m}_{i , j}^{2} ) - {m}_{00}^{2}}}{\sqrt{3} {m}_{00}} \qquad ( 33 )$$

As is clear from the expression (33), all of the sixteen matrix elements of the Mueller matrix are necessary for calculating the depolarization of the sample 100. Specifically, the depolarization of the sample 100 can be easily and quickly calculated utilizing the measuring apparatus according to this embodiment.

### 5-2: Retardation, Principal Axis Direction, and Dichroism

The Mueller matrix of a sample having a retardation, principal axis direction, and dichroism is expressed as follows,

$$X = [ \begin{matrix}{P}_{f}^{2} + {P}_{s}^{2} & AC & AS & 0 \\ AC & ( {P}_{f}^{2} + {P}_{s}^{2} ) {C}^{2} + {S}^{2} B cos Δ & CS ( {P}_{f}^{2} + {P}_{s}^{2} - B cos Δ ) & - BS sin Δ \\ AS & CS ( {P}_{f}^{2} + {P}_{s}^{2} - B cos Δ ) & ( {P}_{f}^{2} + {P}_{s}^{2} ) {S}^{2} + {C}^{2} B cos Δ & BS sin Δ \\ 0 & BS sin Δ & - BC sin Δ & B cos Δ\end{matrix} ] \qquad ( 34 )$$

where,

A=±(P_{f}²−Pₛ²), B=2P_{f}Pₛ, C=cos 2φ, S=sin 2φ (35)

P_{f} and Pₛ respectively indicate the principal transmittances along the fast axis and the slow axis (f-axis and s-axis). phi indicates the direction of the fast axis (principal axis direction).

The retardation delta, the principal axis direction phi, and the principal transmittances P_{f} and Pₛ along the fast axis and the slow axis are expressed as follows based on the expressions (34) and (35).

$$\begin{matrix}φ = \frac{1}{2} {tan}^{- 1} \frac{{m}_{13}}{{m}_{32}} or φ = \frac{1}{2} {tan}^{- 1} \frac{{m}_{02}}{{m}_{10}} & ( 36 ) \\ Δ = {tan}^{- 1} \frac{\sqrt{{m}_{13}^{2} + {m}_{32}^{2}}}{{m}_{33}} & ( 37 ) \\ {P}_{f} = \sqrt{{m}_{00} + \sqrt{{m}_{10}^{2} + {m}_{02}^{2}}} & ( 38 ) \\ {P}_{s} = \sqrt{{m}_{00} - \sqrt{{m}_{10}^{2} + {m}_{02}^{2}}} & ( 39 )\end{matrix}$$

Specifically, the retardation, the principal axis direction, and the dichroism of the sample 100 can be calculated by utilizing the matrix elements of the Mueller matrix of the sample 100.

### 5-3: Reflection Coefficient and Retardation

A Mueller matrix) X_{surf} relating to the reflection coefficient and the retardation in a primary scattering medium is expressed as follows.

$${X}_{surf} = [ \begin{matrix}{r}_{p}^{2} + {r}_{s}^{2} & {r}_{p}^{2} - {r}_{s}^{2} & 0 & 0 \\ {r}_{p}^{2} - {r}_{s}^{2} & {r}_{p}^{2} + {r}_{s}^{2} & 0 & 0 \\ 0 & 0 & 2 {r}_{p} {r}_{s} cos σ & 2 {r}_{p} {r}_{s} sin σ \\ 0 & 0 & - 2 {r}_{p} {r}_{s} sin σ & 2 {r}_{p} {r}_{s} cos σ\end{matrix} ] \qquad ( 40 )$$

rₚ, rₛ, and sigma respectively indicate the amplitude reflection coefficients for p-polarized light and s-polarized light and the retardation between p-polarized light and s-polarized light.

The amplitude reflection coefficients rₚ, and rₛ and the retardation sigma are calculated as follows.

$$\begin{matrix}{r}_{p} = \sqrt{{m}_{00} + {m}_{01}} & ( 41 ) \\ {r}_{s} = \sqrt{{m}_{00} - {m}_{01}} & ( 42 ) \\ σ = {tan}^{- 1} \frac{{m}_{23}}{{m}_{33}} & ( 43 )\end{matrix}$$

Specifically, the amplitude reflection coefficients for p-polarized light and s-polarized light and the retardation between p-polarized light and s-polarized light can be calculated by utilizing the matrix elements of the Mueller matrix of the sample 100.

When the measuring apparatus according to the invention forms an optical characteristic element measuring unit that calculates these optical characteristic elements (physical quantities that indicate the optical characteristics of the sample 100), the control device 80 (calculation section 60) may calculate these optical characteristic elements. In this case, the optical characteristic element measuring unit may be configured as a device that outputs the value of each optical characteristic element.

### (6) MODIFICATION

The invention is not limited to the above-described embodiments. Various modifications and variations can be made. A modification of the method that calculates the matrix elements of the Mueller matrix of the sample 100 based on the light intensity information and the principal axis directions of the optical elements is described below.

The expressions (13) and (14) and the expressions (15) and (16) can be generalized as follows.

fₐ(α)=x₀+x₁ cos α−x₃ sin α (44)

f_{b}(α)=x₀+x₂ cos α−x₃ sin α (45)

In this modification, x₀, x₁, x₂, and x₃ are calculated using approximation by a least-square method while changing alpha to an arbitrary angle. This step is described below taking the expression (44) as an example.

In the expression (44), alpha is changed N times, and the measured value f′ₐ(alpha) containing an error is approximated to the theoretical value fₐ(alpha) in the expression (44) to calculate x₀, x₁, and x₃. The following expression is given using the least-square method.

$$\begin{matrix}\begin{matrix}E = {\sum }_{i = 0}^{N - 1} {( {f}_{a} ( α ) - {f}_{a}^{′} ( α ) )}^{2} \\ = {\sum }_{i = 0}^{N - 1} {( {x}_{0} + {x}_{1} cos {α}_{i} - {x}_{3} sin {α}_{i} - {f}_{a}^{′} ( α ) )}^{2} \\ = {Nx}_{0}^{2} + {x}_{1}^{2} {\sum }_{i = 0}^{N - 1} {cos}^{2} {α}_{i} + {x}_{3}^{2} {\sum }_{i = 0}^{N - 1} {sin}^{2} {α}_{i} + 2 {x}_{0} {x}_{1} {\sum }_{i = 0}^{N - 1} cos {α}_{i} + \\ 2 {x}_{0} {x}_{2} {\sum }_{i = 0}^{N - 1} sin {α}_{i} - 2 {x}_{1} {x}_{3} {\sum }_{i = 0}^{N - 1} cos {α}_{i} sin {α}_{i} \\ - 2 {x}_{0} {\sum }_{i = 0}^{N - 1} {f}_{a}^{′} ( {α}_{i} ) - 2 {x}_{1} {\sum }_{i = 0}^{N - 1} {f}_{a}^{′} ( {α}_{i} ) cos {α}_{i} + \\ 2 {x}_{3} {\sum }_{i = 0}^{N - 1} {f}_{a}^{′} ( {α}_{i} ) sin {α}_{i} + {\sum }_{i = 0}^{N - 1} {{f}_{a}^{′} ( {α}_{i} )}^{2}\end{matrix} & ( 46 ) \\ \frac{\partial E}{\partial {x}_{0}} = 0 , \frac{\partial E}{\partial {x}_{1}} = 0 , \frac{\partial E}{\partial {x}_{2}} = 0. & ( 47 )\end{matrix}$$

a₀, a₁, and a₂ that satisfy the above expressions are calculated.

The following expression can be derived from the expressions (46) and (47).

$$\frac{\partial E}{\partial {x}_{0}} = 2 {Nx}_{0} + 2 {x}_{1} {\sum }_{i = 0}^{N - 1} cos {α}_{i} + 2 {x}_{3} {\sum }_{i = 0}^{N - 1} sin {α}_{i} - 2 {\sum }_{i = 0}^{N - 1} {f}_{a}^{′} ( {α}_{i} ) = 0 \\ \frac{\partial E}{\partial {x}_{1}} = 2 {x}_{1} {\sum }_{i = 0}^{N - 1} {cos}^{2} {α}_{i} + 2 {x}_{0} {\sum }_{i = 0}^{N - 1} cos {α}_{i} + 2 {x}_{1} {\sum }_{i = 0}^{N - 1} cos {α}_{i} sin {α}_{i} - 2 {\sum }_{i = 0}^{N - 1} {f}_{s}^{′} ( {α}_{i} ) cos {α}_{i} = 0 \\ \frac{\partial E}{\partial {x}_{1}} = 2 {x}_{3} {\sum }_{i = 0}^{N - 1} {sin}^{2} {α}_{i} + 2 {x}_{0} {\sum }_{i = 0}^{N - 1} sin {α}_{i} + 2 {x}_{1} {\sum }_{i = 0}^{N - 1} cos {α}_{i} sin {α}_{i} + 2 {\sum }_{i = 0}^{N - 1} {f}_{a}^{′} ( {α}_{i} ) sin {α}_{i} = 0 \qquad ( 48 )$$

The expression (48) can be rewritten as follows using a matrix.

$$[ \begin{matrix}1 & \frac{1}{N} Σcos {α}_{i} & \frac{1}{N} Σsin {α}_{i} \\ \frac{1}{N} Σcos {α}_{i} & \frac{1}{N} {Σcos}^{2} {α}_{i} & \frac{1}{N} Σsin {α}_{i} cos {α}_{i} \\ \frac{1}{N} Σsin {α}_{i} & \frac{1}{N} Σcos {α}_{i} sin {α}_{i} & Σ \frac{1}{N} {sin}^{2} {α}_{i}\end{matrix} ] [ \begin{matrix}{x}_{0} \\ {x}_{1} \\ {x}_{3}\end{matrix} ] - [ \begin{matrix}\frac{1}{N} Σ {f}_{a}^{′} ( {α}_{i} ) \\ \frac{1}{N} Σ {f}_{a}^{′} ( {α}_{i} ) cos {α}_{i} \\ - \frac{1}{N} Σ {f}_{a}^{′} ( {α}_{i} ) sin {α}_{i}\end{matrix} ] = 0 \qquad ( 49 )$$

The following expression is obtained by calculating the inverse matrix.

$${x}_{1} = \frac{( \begin{matrix}\frac{1}{N} Σcos {α}_{i} \cdot \frac{1}{N} Σsin {α}_{i} - \\ \frac{1}{N} Σcos {α}_{i} sin {α}_{i}\end{matrix} ) ( \begin{matrix}\frac{1}{N} Σsin {α}_{i} \cdot \frac{1}{N} Σ {f}_{a}^{′} ( {α}_{i} ) + \\ \frac{1}{N} Σ {f}_{a}^{′} ( {α}_{i} ) sin {α}_{i}\end{matrix} )}{( \begin{matrix}\frac{1}{N} Σcos {α}_{i} - \\ \frac{1}{N} Σcos {α}_{i} sin {α}_{i}\end{matrix} ) ( \begin{matrix}\frac{1}{N} Σcos {α}_{i} \frac{1}{N} Σsin {α}_{i} - \\ \frac{1}{N} Σcos {α}_{i} sin {α}_{i}\end{matrix} )} \frac{- ( \begin{matrix}{( \frac{1}{N} Σsin {α}_{i} )}^{2} - \\ \frac{1}{N} {Σsin}^{2} {α}_{i}\end{matrix} ) ( \begin{matrix}\frac{1}{N} Σcos {α}_{i} \cdot \frac{1}{N} Σ {f}_{a}^{′} ( {α}_{i} ) - \\ \frac{1}{N} Σ {f}_{a}^{′} ( {α}_{i} ) cos {α}_{i}\end{matrix} )}{- ( {( \frac{1}{N} Σcos {α}_{i} )}^{2} - \frac{1}{N} {Σcos }^{2} {α}_{i} ) ( {( \frac{1}{N} {Σsinα}_{i} )}^{2} - \frac{1}{N} {Σsin}^{2} {α}_{i} )} \\ {x}_{3} = \frac{( \begin{matrix}\frac{1}{N} Σcos {α}_{i} - \\ \frac{1}{N} Σcos {α}_{i} sin {α}_{i}\end{matrix} ) ( \begin{matrix}\frac{1}{N} Σcos {α}_{i} \cdot \frac{1}{N} Σ {f}_{a}^{′} ( {α}_{i} ) - \\ \frac{1}{N} Σ {f}_{a}^{′} ( {α}_{i} ) cos {α}_{i}\end{matrix} )}{( \begin{matrix}\frac{1}{N} Σcos {α}_{i} - \\ \frac{1}{N} Σcos {α}_{i} sin {α}_{i}\end{matrix} ) ( \begin{matrix}\frac{1}{N} Σcos {α}_{i} \frac{1}{N} Σsin {α}_{i} - \\ \frac{1}{N} Σcos {α}_{i} sin {α}_{i}\end{matrix} )} \frac{- ( \begin{matrix}{( \frac{1}{N} Σcos {α}_{i} )}^{2} - \\ \frac{1}{N} {Σcos}^{2} {α}_{i}\end{matrix} ) ( \begin{matrix}\frac{1}{N} {Σsinα}_{i} \cdot \frac{1}{N} Σ {f}_{a}^{′} ( {α}_{i} ) + \\ \frac{1}{N} Σ {f}_{a}^{′} ( {α}_{i} ) sin {α}_{i}\end{matrix} )}{- ( \begin{matrix}{( \frac{1}{N} Σcos {α}_{i} )}^{2} - \\ \frac{1}{N} {Σcos }^{2} {α}_{i}\end{matrix} ) ( \begin{matrix}{( \frac{1}{N} Σsin {α}_{i} )}^{2} - \\ \frac{1}{N} {Σsin}^{2} {α}_{i}\end{matrix} )} \\ {x}_{0} = \frac{1}{N} Σ {f}_{a}^{′} ( {α}_{i} ) - \frac{1}{N} Σ cos ( {α}_{i} ) {x}_{1} - \frac{1}{N} Σsin {α}_{i} {x}_{3} \qquad ( 50 )$$

According to this step, since the amount of phase modulation that maximizes the detection sensitivity can be selected corresponding to the characteristics of the sample (sample 100), a highly accurate measurement can be achieved.

### (7) CALIBRATION

When measuring optical characteristics using a device, a change in polarization state due to the optical element or an error during an optical axis adjustment occurs. Therefore, an error specific to an experimental optical system is not compensated for merely by performing the above-described analysis. Therefore, calibration may be performed in order to eliminate an error due to the birefringence of the experimental optical system and the like. Accurate measurement results can be obtained by performing calibration.

In the invention, calibration may be performed by applying an arbitrary calibration method that can be applied to the measuring apparatus 1.

### (8) MEASUREMENT RESULTS

The measurement results obtained by the measuring apparatus according to an embodiment to which the invention is applied are given below.

The following expressions (51) to (56) show matrix expressions of the Mueller matrix of the measurement target (measurement results) and theoretical values.

$$\begin{matrix}NULL ( without sample ) & \\ Measured Value & \\ X = [ \begin{matrix}1.00 & 0.00 & 0.00 & 0.00 \\ 0.00 & 1.00 & 0.00 & 0.00 \\ 0.00 & 0.00 & 1.00 & 0.00 \\ 0.00 & 0.00 & 0.00 & 1.00\end{matrix} ] & ( 51 ) \\ Theoretical Value & \\ X = [ \begin{matrix}1 & 0 & 0 & 0 \\ 0 & 1 & 0 & 0 \\ 0 & 0 & 1 & 0 \\ 0 & 0 & 0 & 1\end{matrix} ] & ( 52 ) \\ Polarizer ( Polaroid ) \\ Measured Value & \\ X = [ \begin{matrix}1 & - 0.99 & 0.14 & 0.00 \\ - 1.00 & 1.00 & - 0.11 & - 0.01 \\ 0.11 & 0.16 & 0.02 & - 0.02 \\ - 0.03 & 0.01 & 0.06 & 0.01\end{matrix} ] & ( 53 ) \\ Theoretical Value & \\ X = [ \begin{matrix}1 & - 1 & 0 & 0 \\ - 1 & 1 & 0 & 0 \\ 0 & 0 & 0 & 0 \\ 0 & 0 & 0 & 0\end{matrix} ] & ( 54 ) \\ Quarter \text{-} wave Plate \\ Measured Value & \\ X = [ \begin{matrix}1 & 0.02 & 0.00 & - 0.01 \\ 0.00 & 1.01 & 0.07 & - 0.04 \\ 0.01 & - 0.04 & - 0.06 & 0.98 \\ - 0.01 & 0.00 & - 0.94 & 0.09\end{matrix} ] & ( 55 ) \\ Theoretical Value & \\ X = [ \begin{matrix}1 & 0 & 0 & 0 \\ 0 & 1 & 0 & 0 \\ 0 & 0 & 0 & 1 \\ 0 & 0 & - 1 & 0\end{matrix} ] & ( 56 )\end{matrix}$$

The expressions (51) and (52) show measured values and theoretical values in a state in which the sample was not provided. The expressions (53) and (54) show measured values and theoretical values obtained for a polarizer (polaroid) as the sample. The expressions (55) and (56) show measured values and theoretical values obtained for a quarter-wave plate as the sample. It was confirmed that results that almost coincide with the theoretical values could be obtained by the measuring apparatus from the comparison between the measured values and the theoretical values.

Note that the expressions (51) to (56) show Mueller matrices at one point (area corresponding to one light-receiving element) of the measurement target. The measurement results over the surface of the measurement target (Mueller matrix distribution state) can be obtained by extending the measurement results over the entire surface (area corresponding to a plurality of light-receiving elements).

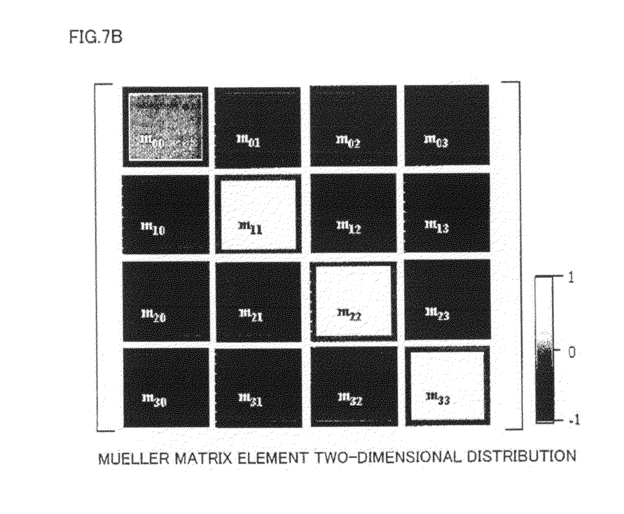

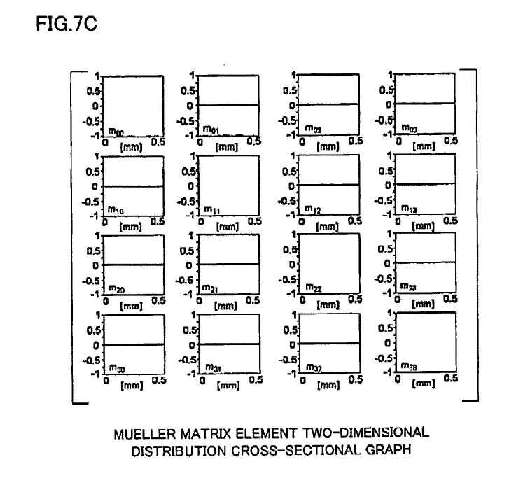

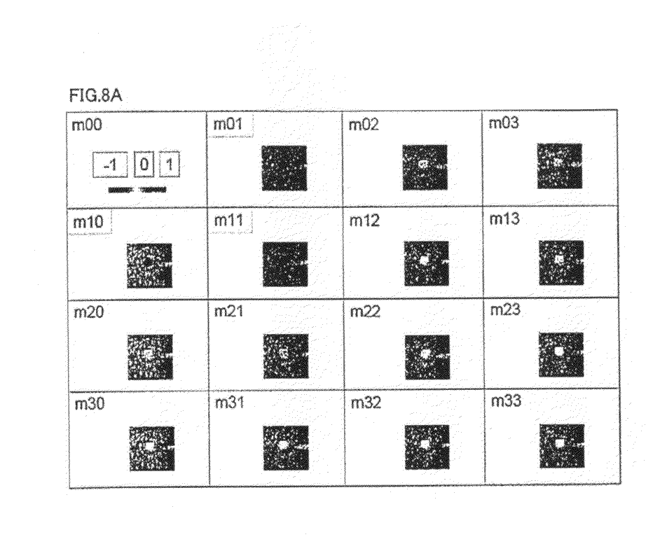

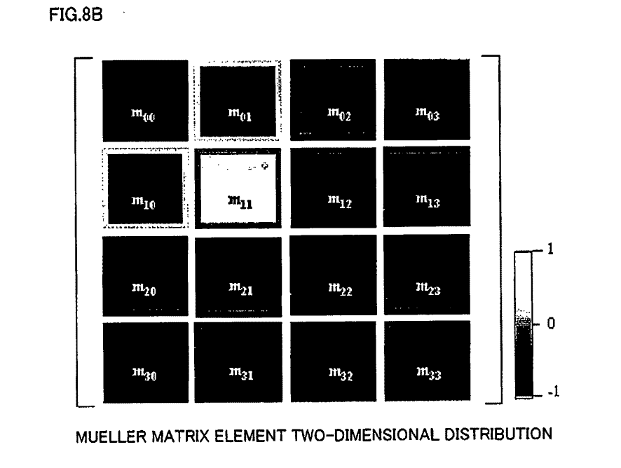

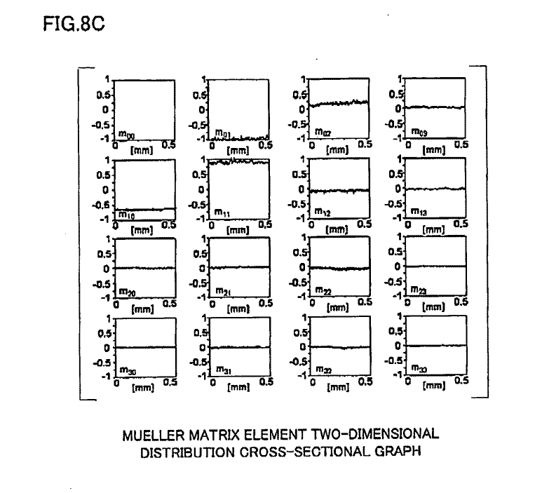

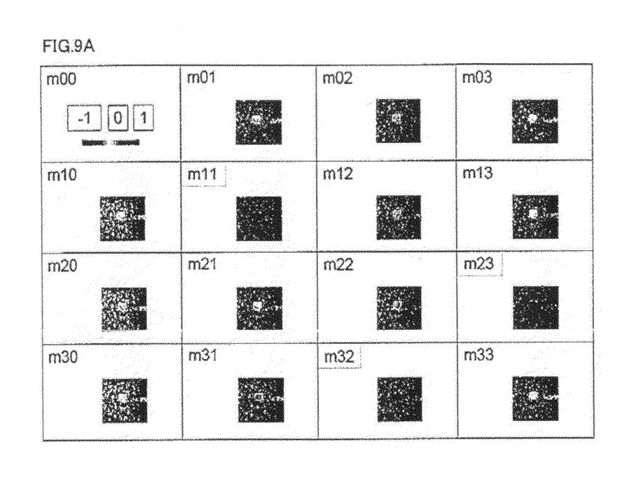

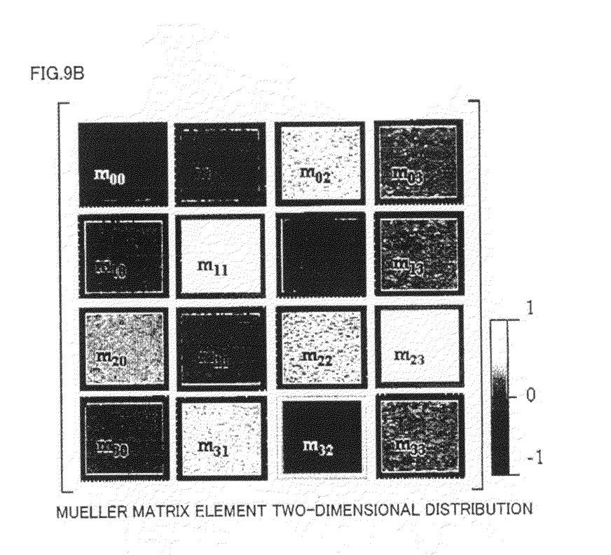

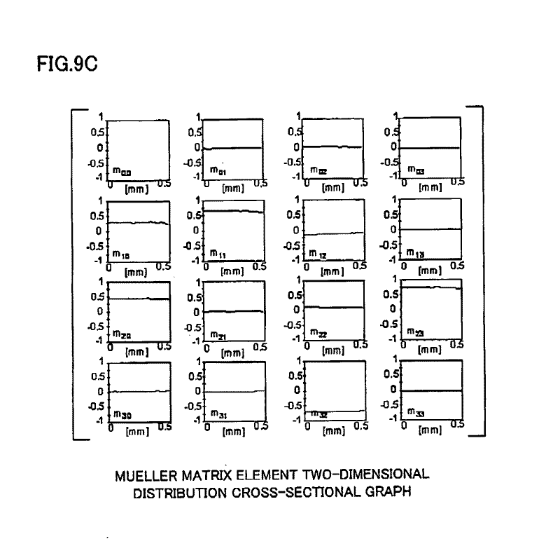

FIGS. 7A to 9C shows measurement result when two-dimensionally measuring the sample utilizing the measuring apparatus according to an embodiment to which the invention is applied. FIGS. 7A to 7C show measurement results when the sample was not inserted. FIGS. 8A to 8C and FIGS. 9A to 9C respectively show measurement results for a polarizer (polaroid) and a quarter-wave plate of which the principal axis direction was set at 90° as the sample. In FIGS. 7A, 8A, and 9A, other elements are standardized so that m₀₀ that indicates the light intensity is one. Each element is displayed using a blue-red color bar in the range from −1 to 1. The center of the image of each element is the sample. FIGS. 7B, 8B, and 9B are enlarged diagrams showing the measurement results shown in FIGS. 7A, 8A, and 9A, respectively. The measurement results are displayed using a black-white color bar. FIGS. 7C, 8C, and 9C show the measurement results as the distribution of the Mueller matrix elements.

As shown in FIGS. 7A to 9C, the matrix elements in a predetermined area of the sample can be calculated using the measuring apparatus. Specifically, the invention can measure a broad measurement target as a measurement surface. According to the invention, as shown in FIGS. 7A, 8A, and 9A and FIGS. 7B, 8B, and 9B, the distribution of the matrix elements in a predetermined area of the sample can be displayed visually.

The theoretical values when the sample is not inserted, the measurement results when the polarizer is inserted as the sample, and the measurement results when the quarter-wave plate is inserted as the sample are shown by the expressions (52), (54), and (56), respectively. When comparing these expressions with FIGS. 7A to 9C, it was confirmed that the measurement results almost coincide with the theoretical values. Specifically, highly reliable measurements can be performed using the measuring apparatus.

### (9) CONCLUSION

The invention is not limited to the above-described embodiments. Various modifications and variations can be made. The invention includes configurations substantially the same as the configurations described in the above-described embodiments (in function, in method and effect, or in objective and effect). The invention also includes a configuration in which an unsubstantial section of the above-described embodiments is replaced by another section. The invention also includes a configuration having the same effects as those of the above-described configurations, or a configuration capable of achieving the same object as those of the above-described configurations. Further, the invention includes a configuration obtained by adding known technology to the above-described configurations.

For example, the principal axis direction of the optical element that forms the optical system 10 may be changed manually. In this case, the calculation step may be performed based on the principal axis direction information acquired by the detection section.

The optical system 10 may utilize a light source that emits linearly polarized light instead of the light source 12 and the polarizer 22. The light source may be configured so that the direction of the linearly polarized light can be arbitrarily changed.

The measuring apparatus 1 may acquire the light intensity information while successively rotating the optical elements (half-wave plate 24, first quarter-wave plate 26, second quarter-wave plate 34, and analyzer 36) that form the optical system 10. This makes it possible to acquire the light intensity information efficiently and quickly so that the sample 100 can be measured in real time.

However, the optical characteristic measuring apparatus according to this embodiment must acquire the light intensity information while changing the setting (delta′ and 2theta₃) of the second phase modulation section 35 with respect to incident polarized light (light modulated by the first phase modulation section 25 set at delta and 2theta₂), as described above. Therefore, in order to acquire data utilizing the optical system that is rotated successively, it is necessary to change delta, 2theta₂, delta, and 2theta₃ in different cycles. Specifically, necessary data can be acquired utilizing the optical element that is rotated successively by rotating the optical elements (half-wave plate 24, first quarter-wave plate 26, second quarter-wave plate 34, and analyzer 36) so that delta, 2theta₂, deltas, and 2theta₃ are changed in different cycles. For example, necessary data can be acquired by rotating the optical elements (half-wave plate 24, first quarter-wave plate 26, second quarter-wave plate 34, and analyzer 36) at a disjoint rotational ratio.

The expression (11) that indicates the light intensity of the measurement light can be transformed as follows.

$$\begin{matrix}I = {S}_{0} + {S}_{1} cos 2 {θ}_{3} cos ( 2 {θ}_{3} - 2 {θ}_{4} ) + \\ {S}_{2} sin 2 {θ}_{3} cos ( 2 {θ}_{3} - 2 {θ}_{4} ) - {S}_{3} sin ( 2 {θ}_{3} - 2 {θ}_{4} ) \\ = {S}_{0} + cos {δ}^{′} ( {S}_{1} cos 2 {θ}_{3} + {S}_{2} sin 2 {θ}_{3} ) - {S}_{3} sin {δ}^{′} \\ = {S}_{0} + {S}_{12} cos {δ}^{′} - {S}_{3} sin {δ}^{′}\end{matrix} \qquad ( 57 )$$

where,

S₁₂=S₁ cos 2θ₃+S₂ sin 2θ₃ (58)

S₀, S₁₂, and S₃ can be obtained by changing delta' a plurality of times. S₁ and S₂ can be obtained by changing 2theta₃.

Each row of the expression (6) can be given as follows.

$$\begin{matrix}{S}_{i} = {m}_{i 0} + {m}_{i 1} cos 2 {θ}_{2} cos δ + {m}_{i 2} sin 2 {θ}_{2} cos δ - {m}_{i 3} sin δ \\ = {m}_{i 0} + ( {m}_{i 1} cos 2 {θ}_{2} + {m}_{i 2} sin 2 {θ}_{2} ) cos δ - {m}_{i 3} sin δ \\ = {m}_{i 0} + {M}_{i 12} cos δ - {m}_{i 3} sin δ\end{matrix} \qquad ( 59 )$$

where,

Mᵢ₁₂=mᵢ₁ cos 2θ₂+m₁₂ sin 2θ₂ (60)

i is 0, 1, 2, or 3.

Mᵢ₀, Mᵢ₁₂, and mᵢ₃ can be obtained by changing delta a plurality of times. mᵢ₁ and mᵢ₂ can be obtained by changing 2theta₂.

Table 5 shows a specific example when delta, 2theta₂, delta′, and 2theta₃ are successively changed in different cycles. Since 2theta₂ and 2theta₃ indicate the principal axis directions of the elements, one cycle is 180°.

TABLE 5

| 2θ2 | δ = 4θ1 − 2θ2 | 2θ3 | δ′ = 2θ3 − 2θ4 |
|---|---|---|---|
| [symbol] | [symbol] | 0 | 0 |
| 120 | 72 | 60 | 90 |
| 240 | 144 | 120 | 180 |
| 0 | 216 | 180 | 270 |
| 120 | 288 | 240 | 0 |
| [symbol] | [symbol] | 300 | 90 |
| 0 | 72 | 0 | 180 |
| 120 | 144 | 60 | 270 |
| 240 | 216 | 120 | 0 |
| 0 | 288 | 180 | 90 |
| 120 | 0 | 240 | 180 |
| 240 | 72 | 300 | 270 |
| 0 | 144 | 0 | 0 |
| 120 | 216 | 60 | 90 |
| 240 | 288 | 120 | 180 |
| [symbol] | [symbol] | 180 | 270 |
| 120 | 72 | 240 | 0 |
| 240 | 144 | 300 | 90 |
| 0 | 216 | 0 | 180 |
| 120 | 288 | 60 | 270 |
| [symbol] | [symbol] | 120 | 0 |
| 0 | 72 | 180 | 90 |
| 120 | 144 | 240 | 180 |
| 240 | 216 | 300 | 270 |
| 0 | 288 | 0 | 0 |
| 120 | 0 | 60 | 90 |
| 240 | 72 | 120 | 180 |
| 0 | 144 | 180 | 270 |
| 120 | 216 | 240 | 0 |
| 240 | 288 | 300 | 90 |
| [symbol] | [symbol] | 0 | 180 |
| 120 | 72 | 60 | 270 |
| 240 | 144 | 120 | 0 |
| 0 | 216 | 180 | 90 |
| 120 | 288 | 240 | 180 |
| [symbol] | [symbol] | 300 | 270 |
| 0 | 72 | 0 | 0 |
| 120 | 144 | 60 | 90 |
| 240 | 216 | 120 | 180 |
| 0 | 288 | 180 | 270 |
| 120 | 0 | 240 | 0 |
| 240 | 72 | 300 | 90 |
| 0 | 144 | 0 | 180 |
| 120 | 216 | 60 | 270 |
| 240 | 288 | 120 | 0 |
| [symbol] | [symbol] | 180 | 90 |
| 120 | 72 | 240 | 180 |
| 240 | 144 | 300 | 270 |
| 0 | 216 | 0 | 0 |
| 120 | 288 | 60 | 90 |
| [symbol] | [symbol] | 120 | 180 |
| 0 | 72 | 180 | 270 |
| 120 | 144 | 240 | 0 |
| 240 | 216 | 300 | 90 |
| 0 | 288 | 0 | 180 |
| 120 | 0 | 60 | 270 |
| 240 | 72 | 120 | 0 |
| 0 | 144 | 180 | 90 |
| 120 | 216 | 240 | 180 |
| 240 | 288 | 300 | 270 |
| 0 | 0 | 0 | 0 |

[symbol]

indicates data missing or illegible when filed

Table 6 shows the rotational angle of each element.

TABLE 6

| θ1 | θ2 | θ3 | θ4 |
|---|---|---|---|
| [symbol] | [symbol] | [symbol] | [symbol] |
| 48 | 60 | 30 | −15 |
| 96 | 120 | 60 | −30 |
| 144 | 180 | 90 | −45 |
| 192 | 240 | 120 | −60 |
| 240 | 300 | 150 | −75 |
| [symbol] | [symbol] | [symbol] | [symbol] |
| 336 | 420 | 210 | −105 |
| 384 | 480 | 240 | −120 |
| 432 | 540 | 270 | −135 |
| 480 | 600 | 300 | −150 |
| 528 | 660 | 330 | −165 |
| [symbol] | [symbol] | [symbol] | [symbol] |
| 624 | 780 | 390 | −195 |
| 672 | 840 | 420 | −210 |
| 720 | 900 | 450 | −225 |
| 768 | 960 | 480 | −240 |
| 816 | 1020 | 510 | −255 |
| [symbol] | [symbol] | [symbol] | [symbol] |
| 912 | 1140 | 570 | −285 |
| 960 | 1200 | 600 | −300 |
| 1009 | 1260 | 630 | −315 |
| 1056 | 1320 | 660 | −330 |
| 1104 | 1380 | 690 | −345 |
| [symbol] | [symbol] | [symbol] | [symbol] |
| 1200 | 1500 | 750 | −375 |
| 1248 | 1560 | 780 | −390 |
| 1286 | 1620 | 810 | −405 |
| 1344 | 1680 | 840 | −420 |
| 1392 | 1740 | 870 | −435 |
| [symbol] | [symbol] | [symbol] | −450 |
| 1488 | 1860 | 930 | −465 |
| 1536 | 1920 | 960 | −480 |
| 1584 | 1980 | 990 | −495 |
| 1632 | 2040 | 1020 | −510 |
| 1680 | 2100 | 1050 | −525 |
| [symbol] | [symbol] | [symbol] | [symbol] |
| 1776 | 2220 | 1110 | −555 |
| 1824 | 2280 | 1140 | −570 |
| 1872 | 2340 | 1170 | −585 |
| 1920 | 2400 | 1200 | −600 |
| 1968 | 2460 | 1230 | −615 |
| [symbol] | [symbol] | [symbol] | [symbol] |
| 2064 | 2580 | 1280 | −645 |
| 2112 | 2640 | 1320 | −660 |
| 2160 | 2700 | 1350 | −675 |
| 2208 | 2760 | 1380 | −690 |
| 2256 | 2820 | 1410 | −705 |
| [symbol] | [symbol] | [symbol] | [symbol] |
| 2352 | 2940 | 1470 | −735 |
| 2400 | 3000 | 1500 | −750 |
| 2448 | 3060 | 1530 | −765 |
| 2496 | 3120 | 1560 | −780 |
| 2544 | 3180 | 1590 | −785 |
| [symbol] | [symbol] | [symbol] | [symbol] |
| 2640 | 3300 | 1650 | −825 |
| 2688 | 3360 | 1680 | −840 |
| 2736 | 3420 | 1710 | −855 |
| 2784 | 3480 | 1740 | −870 |
| 2832 | 3540 | 1770 | −885 |
| 2080 | 3600 | 1800 | −900 |

[symbol]

indicates data missing or illegible when filed

As shown in Table 6, the phase shift shown in Table 5 can be obtained by rotating each element. The matrix elements of the matrix that indicates the optical characteristics of the measurement target can be calculated based on the light intensity informational thus obtained and the corresponding principal axis direction information. When acquiring the light intensity information utilizing the optical system of which the optical elements are rotated successively, since necessary data can be acquired in a short time as compared with the case where the optical elements are rotated and stopped, optical characteristics can be measured more quickly.

When acquiring the light intensity information utilizing the optical system 10 of which the optical elements (half-wave plate 24, first quarter-wave plate 26, second quarter-wave plate 34, and analyzer 36) are rotated successively, it is necessary to synchronize the optical elements.

According to the above-described example, light intensity information appropriate for analysis can be acquired by synchronizing the half-wave plate 24, the first quarter-wave plate 26, the second quarter-wave plate 34, and the analyzer 36 so that the principal axis directions of the half-wave plate 24, the first quarter-wave plate 26, the second quarter-wave plate 34, and the analyzer 36 are set at 0° at the same time.

The synchronization control method is not particularly limited. For example, synchronization may be controlled based on the principal axis direction of the first quarter-wave plate 26. The synchronization control step is described below. The half-wave plate 24, the first quarter-wave plate 26, the second quarter-wave plate 34, and the analyzer 36 are rotated at a given rotational ratio. The principal axis direction theta₁ of the half-wave plate 24 when the principal axis direction theta₂ of the first quarter-wave plate 26 is set at 0° (when the principal axis direction has coincided with the principal axis direction of the polarizer 22) is detected utilizing the first and second driver/detection sections 72 and 74. The principal axis direction theta₁ of the half-wave plate 24 is changed by applying a voltage corresponding to the difference detected by the first driver/detection section 72 (actuator) to synchronize the half-wave plate 24 with the first quarter-wave plate 26. Likewise, the second quarter-wave plate 34 and the analyzer 36 may be synchronized with the first quarter-wave plate 26.

The above synchronization control step makes it possible to acquire necessary data utilizing the optical system of which the optical elements (half-wave plate 24, first quarter-wave plate 26, second quarter-wave plate 34, and analyzer 36) are rotated successively.

The invention may be applied for inspecting the properties of various substances (e.g., a crystal or a polymer material used as an optical material) and observing a biological material having optical activity and optical absorbency in addition to birefringence by incorporating the device in a microscope device. Moreover, a change in sample due to dynamic load or a reagent can be monitored from various parameters by high-speed measurement.

1. An optical characteristic measuring apparatus that measures the optical characteristics of a measurement target, the optical characteristic measuring apparatus comprising:
an optical system that includes a light source that emits light having a predetermined wavelength, at least five optical elements, and a light-receiving section that receives measurement light obtained by modulating the light by using the at least five optical elements and the measurement target;
a light intensity information acquisition section that acquires light intensity information relating to the measurement light; and
a calculation section that performs a calculation process that calculates at least one of matrix elements of a matrix that indicates the optical characteristics of the measurement target based on a theoretical expression for the light intensity of the measurement light and the light intensity information relating to the measurement light,
the at least five optical elements including a first polarizer, a second polarizer, a half wave plate, a first quarter-wave plate, and a second quarter-wave plate;
the optical system being configured so that the light emitted from the light source is incident on the measurement target through the first polarizes, the half-wave plate, and the first quarter-wave plate, and the light modulated by the measurement target is incident on the light receiving section through the second quarter-wave plate and the second polarizer, at least the half-wave plate, the first quarter-wave plate, the second quarter-wave plate, and the second polarizer being rotatable;
the light intensity information acquisition section acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter wave plate, and the second polarizes;
the calculation section calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables; and
when the principal axis directions of the first quarter-wave plate and the second quarter-wave plate are referred to as theta₂ and theta₃, respectively, the optical system set under the first to Nth conditions being an optical system in which 2theta₂ is a multiple of 180° or an odd-numbered multiple of 90° and 2theta₂ is a multiple of 180° or an odd-numbered multiple of 90°.

2. An optical characteristic measuring apparatus that measures the optical characteristics of a measurement target, the optical characteristic measuring apparatus comprising:
a light intensity information acquisition section that acquires light intensity information relating to measurement light modulated by the measurement target and at least five optical elements included in an optical system; and
a calculation section that performs a calculation process that calculates at least one of matrix elements of a matrix that indicates the optical characteristics of the measurement target based on a theoretical expression for the light intensity of the measurement light and the light intensity information relating to the measurement light,
the at least five optical elements including a first polarizer, a second polarizer, a half wave plate, a first quarter-wave plate, and a second quarter-wave plate, at least the half-wave plate, the first quarter wave plate, the second quarter-wave plate, and the second polarizer being rotatable;
the measurement light being obtained by causing light having a predetermined wavelength emitted from a light source to be incident on the measurement target through the first polarizes, the half-wave plate, and the first quarter-wave plate, and causing the light modulated by the measurement target to be incident on a light-receiving section through the second quarter-wave plate and the second polarizer;
the light intensity information acquisition section acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter-wave plate, and the second polarizer;
the calculation section calculating at least one of the matrix elements based on the theoretical expression for the light intensifies of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables; and
when the principal axis directions of the first quarter wave plate and the second quarter-wave plate are referred to as theta₂ and theta₃, respectively, the optical system set under the first to Nth conditions being an optical system in which 2theta₂ is a multiple of 180° or an odd-numbered multiple of 90° and 2theta₃ is a multiple of 180° or an odd-numbered multiple of 90°.

3. The optical characteristic measuring apparatus as defined in claim 1,
wherein the half-wave plate and the first quarter-wave plate form a first phase modulation section, and the second quarter-wave plate and the second polarizer form a second phase modulation section;
wherein the optical system set under the first to Nth conditions is an optical system in which the first phase modulation section is set under first to Lth (L is an integer equal to or larger than two) conditions that differ in at least one of the principal axis directions of the half-wave plate and the first quarter-wave plate and the second phase modulation section is set under first to Mth (M is an integer equal to or larger than two) conditions that differ in at least one of the principal axis directions of the second quarter-wave plate and the second polarize; and
wherein N=L×M is satisfied.

4. The optical characteristic measuring apparatus as defined in claim 3,
wherein L and M are integers equal to or larger than four.

5. The optical characteristic measuring apparatus as defined in claim 3,
wherein L is equal to M.

6. (canceled)

7. The optical characteristic measuring apparatus as defined in claim 1,
wherein the calculation section calculates all of the matrix elements of the matrix that indicates the optical characteristics of the measurement target.

8. The optical characteristic measuring apparatus as defined in claim 1,
wherein the light intensity information acquisition section acquires the light intensity information relating to the measurement light obtained by the optical system in which the half wave plate, the first quarter-wave plate, the second quarter-wave plate, and the analyzer are rotated successively at a given rotational ratio.

9. The optical characteristic measuring apparatus as defined in claim 8,
wherein the light intensity information acquisition section acquires the light intensity information relating to the measurement light obtained by the optical system in which the half-wave plate, the first quarter-wave plate, the second quarter-wave plate, and the analyzer are rotated successively at a disjoint rotational ratio.

10. The optical characteristic measuring apparatus as defined in claim 1, further comprising:
fast to fourth actuators that drive the half-wave plate, the first quarter-wave plate, the second quarter-wave plate, and the second polarizer,
first to fourth detection sections that detect the principal axis directions of the half wave plate, the first quarter-wave plate, the second quarter-wave plate, and the second polarizer; and
a control signal generation section that generates a control signal that controls operations of the first to fourth actuators,
wherein the control signal generation section generates the control signal based on detection signals from the first to fourth detection sections.

11. An optical characteristic measuring unit comprising the optical characteristic measuring apparatus comprising an optical system that includes a light source that emits light having a predetermined wavelength, at least five optical elements, and a light-receiving section that receives measurement light obtained by modulating the light by using the at least five optical elements and the measurement target; a light intensity information acquisition section that acquires light intensity information relating to the measurement light; and a calculation section that performs a calculation process that calculates at least one of matrix elements of a matrix that indicates the optical characteristics of the measurement target based on a theoretical expression for the light intensity of the measurement light and the light intensity information relating to the measurement light, the at least five optical elements including a first polarizer, a second polarizer, a half wave plate, a first quarter-wave plate, and a second quarter-wave plate; the optical system being configured so that the light emitted from the light source is incident on the measurement target through the first polarizes, the half-wave plate, and the first quarter-wave plate, and the light modulated by the measurement target is incident on the light receiving section through the second quarter-wave plate and the second polarizer, at least the half-wave plate, the first quarter-wave plate, the second quarter-wave plate, and the second polarizer being rotatable; the light intensity information acquisition section acquiring the light intensity information relating to first measurement light to Nth (N is an integer equal to or larger than two) measurement light obtained by the optical system set under first to Nth conditions that differ in at least one of principal axis directions of the half-wave plate, the first quarter-wave plate, the second quarter wave plate, and the second polarizes; the calculation section calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables; and when the principal axis directions of the first quarter-wave plate and the second quarter-wave plate are referred to as theta₂ and theta₃, respectively, the optical system set under the first to Nth conditions being an optical system in which 2theta₂ is a multiple of 180° or an odd-numbered multiple of 90° and 2theta₂ is a multiple of 180° or an odd-numbered multiple of 90°.

12. An optical characteristic measuring method of measuring the optical characteristics of a measurement target, the optical characteristic measuring method comprising:
a light intensity information acquisition step that acquires light intensity information relating to measurement light modulated by the measurement target and at least five optical elements included in an optical system; and
a calculation step that calculates at least one of matrix elements of a matrix that indicates the optical characteristics of the measurement target based on a theoretical expression for the light intensity of the measurement light and the light intensity information relating to the measurement light,
the at least five optical elements including a first polarizer, a second polarizer, a half-wave plate, a first quarter-wave plate, and a second quarter wave plate, at least the half wave plate, the first quarter-wave plate, the second quarter-wave plate, and the second polarizer being rotatable;
the measurement light being obtained by causing light having a predetermined wavelength emitted from a light source to be incident on the measurement target through the first polarizer, the half-wave plate, and the first quarter-wave plate, and causing the light modulated by the measurement target to be incident on a light-receiving section through the second quarter-wave plate and the second polarizer;
the light intensity information acquisition step acquiring the light intensity information relating to first measurement light to Nth (N is an integer equal to or larger than two) measurement light obtained by the optical system set under first to Nth conditions that differ in at least one of principal axis directions of the half wave plate, the first quarter-wave plate, the second quarter-wave plate, and the second polarizer;
the calculation step calculating at least one of the matrix elements based on the theoretical expression for the light intensities of the first measurement light to the Nth measurement light and the light intensity information relating to the first measurement light to the Nth measurement light, the theoretical expression reflecting the principal axis directions of the at least five optical elements and including the matrix elements of the matrix that indicates the optical characteristics of the measurement target as variables; and
when the principal axis directions of the first quarter-wave plate and the second quarter-wave plate are referred to as theta₂ and theta₃, respectively, the optical system set under the first to Nth conditions being an optical system in which 2theta₂ is a multiple of 180° or an odd-numbered multiple of 90° and 2theta₃ is a multiple of 180° or an odd-numbered multiple of 90°.

13. The optical characteristic measuring method as defined in claim 12,
wherein the half wave plate and the first quarter-wave plate form a first phase modulation section, and the second quarter-wave plate and the second polarizer form a second phase modulation section;
wherein the optical system set under the first to Nth conditions is an optical system in which the first phase modulation section is set under first to Lth (L is an integer equal to or larger than two) conditions that differ in at least one of the principal axis directions of the half wave plate and the first quarter-wave plate and the second phase modulation section is set under first to Mth (M is an integer equal to or larger than two) conditions that differ in at least one of the principal axis directions of the second quarter wave plate and the second polarizer; and
wherein N=L×M is satisfied.

14. (canceled)

15. The optical characteristic measuring method as defined in claim 12,
wherein the calculation step calculates all of the matrix elements of the matrix that indicates the optical characteristics of the measurement target.

16. The optical characteristic measuring method as defined in claim 12,
wherein the light intensity information acquisition step acquires the light intensity information relating to the measurement light obtained by the optical system in which the half-wave plate, the first quarter-wave plate, the second quarter-wave plate, and the analyzer are rotated successively at a given rotational ratio.

17. The optical characteristic measuring method as defined in claim 16,
wherein the light intensity information acquisition step acquires the light intensity information relating to the measurement light obtained by the optical system in which the half-wave plate, the first quarter-wave plate, the second quarter-wave plate, and the analyzer are rotated successively at a disjoint rotational ratio.

18. The optical characteristic measuring apparatus as defined in claim 2,
wherein the half-wave plate and the first quarter-wave plate form a first phase modulation section, and the second quarter-wave plate and the second polarizer form a second phase modulation section;
wherein the optical system set under the first to Nth conditions is an optical system in which the first phase modulation section is set under first to Lth (L is an integer equal to or larger than two) conditions that differ in at least one of the principal axis directions of the half-wave plate and the first quarter-wave plate and the second phase modulation section is set under first to Mth (M is an integer equal to or larger than two) conditions that differ in at least one of the principal axis directions of the second quarter-wave plate and the second polarize; and
wherein N=L×M is satisfied.

19. The optical characteristic measuring apparatus as defined in claim 18,
wherein L and M are integers equal to or larger than four.

20. The optical characteristic measuring apparatus as defined in claim 18,
wherein L is equal to M.

21. The optical characteristic measuring apparatus as defined in claim 2,
wherein the calculation section calculates all of the matrix elements of the matrix that indicates the optical characteristics of the measurement target.

22. The optical characteristic measuring apparatus as defined in claim 2,
wherein the light intensity information acquisition section acquires the light intensity information relating to the measurement light obtained by the optical system in which the half wave plate, the first quarter-wave plate, the second quarter-wave plate, and the analyzer are rotated successively at a given rotational ratio.

23. The optical characteristic measuring apparatus as defined in claim 22,
wherein the light intensity information acquisition section acquires the light intensity information relating to the measurement light obtained by the optical system in which the half-wave plate, the first quarter-wave plate, the second quarter-wave plate, and the analyzer are rotated successively at a disjoint rotational ratio.

24. The optical characteristic measuring apparatus as defined in claim 2, further comprising:
fast to fourth actuators that drive the half-wave plate, the first quarter-wave plate, the second quarter-wave plate, and the second polarizer,
first to fourth detection sections that detect the principal axis directions of the half wave plate, the first quarter-wave plate, the second quarter-wave plate, and the second polarizer; and
a control signal generation section that generates a control signal that controls operations of the first to fourth actuators,
wherein the control signal generation section generates the control signal based on detection signals from the first to fourth detection sections.
